(19) United States
(12) Patent Application Publication
(10) Pub. No.: US 2025/0241338 A1
(43) Pub. Date: Jul. 31, 2025

(54) AN EDIBLE FOOD PRODUCT WITH A MEAT-LIKE TEXTURE AT LOW AND HIGH TEMPERATURE AND PRODUCTION METHOD THEREOF

(71) Applicant: SUPRÊME, Evry-Courcouronnes Cedex (FR)

(72) Inventors: Victor CONVERSA MARTINEZ, Evry-Courcouronnes Cedex (FR); Marion GAFF, Evry-Courcouronnes Cedex (FR); Victor SAYOUS, Evry-Courcouronnes Cedex (FR)

(21) Appl. No.: 18/854,599

(22) PCT Filed: Apr. 7, 2023
(86) PCT No.: PCT/EP2023/059342

§ 371 Date: Oct. 7, 2024

(30) Foreign Application Priority Data
Apr. 7, 2022 (EP) 22305487.5

(51) Int. Cl. A23J 3/22; A23J 3/04; A23L 13/40

(52) U.S. Cl. CPC A23J 3/227; A23J 3/04; A23L 13/43

(57) ABSTRACT

The invention relates to an edible food product and its method of manufacture. The edible food product comprises a fatty matrix, said fatty matrix comprising more than 40.00% of plant fat and/or fermented fat in weight with respect to a total weight of fatty matrix, said fatty matrix comprising triglycerides, said triglycerides comprising: —more than 40% in weight of unsaturated C18 fatty acids with less than four carbon-carbon double bonds, with respect to a total weight of said triglycerides, —more than 2% in weight of polyunsaturated C18 fatty acids, with respect to a total weight of said triglycerides, said fatty matrix further comprising more than 2.10% of proteins in weight with respect to the total weight of the fatty matrix, said proteins including non-human animal proteins.

### FIELD OF THE INVENTION

The present invention relates to the field of food products. In particular, the invention relates to the field of meat substitutes. In particular, this invention can provide new edible products with a meat-like texture over a wide range of temperature and a production method thereof. This edible product with a meat-like texture can be considered as a substitute for meat and for example can have a foie gras texture.

### DESCRIPTION OF RELATED ART

From 2020 to 2050, the world population will rise by an estimated 2 billion (United Nations and Affairs, 2015). Humanity will face major challenges among which is food production, including meat production. Traditional meat production is a resource-intensive process that generates a significant environmental footprint. Domesticated animals are raised in agricultural settings requiring substantial quantities of fresh water, feed, land, and other resources (Mark J Post: “Cultured meat from stem cells: Challenges and prospects” Meat science, Elsevier Science, GB, vol 92, no 3, 3 Apr. 2012, pages 297-301). Consequently, food production is already considered responsible for approximately 26% of global greenhouse gas (GHG) emissions, of which livestock & fisheries account for 31%. A reduction in global meat consumption could lead to a significant reduction in emissions of greenhouse gases related to climate change (Martin & Brandão, 2017. Evaluating the environmental consequences of Swedish food consumption and dietary choices. Sustainability, 9(12), 2227), particularly if reductions are made in countries where meat consumption is high or rising (Stoll-Kleemann & Schmidt, 2017, Reducing meat consumption in developed and transition countries to counter climate change and biodiversity loss: A review of influence factors. Regional Environmental Change, 17(5), 1261-1277.; Collier et al. 2021, Identifying barriers to decreasing meat consumption and increasing acceptance of meat substitutes among Swedish consumers; Appetite 167 (2021) 105643.). Moreover, animal welfare is a growing concern. For example, the European Union has put in place various laws concerning animal welfare since 1986. Various directives provide rules for the protection of laying hens (in 1986 and 1988), calves and pigs (in 1991), and, in 1998, the directive 98/58/EC of the Council on the protection of animals kept for farming purposes has established general rules concerning the protection of animals, whatever the species.

Several meat substitutes have been developed from insects, vegetable components and/or cultured animal, fungus or vegetable cells (i.e. cell technology). In particular, cell technologies are rapidly developing to respond to the new demand of consumers.

Crucial to increase people's willingness to consume meat replacements, the product, as a substitute, should mimic the aesthetic and organoleptic qualities of meat such as size, appearance, flavour and texture (Macdiarmid et al., 2016, Eating like there's no tomorrow: Public awareness of the environmental impact of food and reluctance to eat less meat as part of a sustainable diet. Appetite. 2016 Jan. 1; 96:487-493). Fat alternatives improving the texture of food products have been previously described. US patent publication 4,324,807 discloses an alternative adipose tissue obtained using vegetable oil and animal protein. Although the technology of texturization to improve the feel and taste of these products is continuously improving, meat analogues still differ from genuine meat in terms of mouthfeel and flavour (Samard & Ryu, 2019; A comparison of physicochemical characteristics, texture, and structure of meat analogue and meats. Journal of the Science of Food and Agriculture, 99(6), 2708-2715). Moreover, consumers also reported being unfamiliar with how to prepare meals with meat substitutes, making it more difficult and time consuming to make a satisfying, tasty meal using such products than using meat (Elzerman et al., 2013; Exploring meat substitutes: Consumer experiences and contextual factors. British Food Journal, 115(5), 700-710).

Edible alternatives having good nutrition value are also described. For instance, European patent publication EP 3 903 593 describes a structured fat system using vegetable oil as well as animal proteins as suitable emulsifiers.

Texture has been considered as one of the most important qualities of meat analogues (Sha & Xiong, 2020). Many methods have been proposed for improving the texture of meat analogues. For example, it has been proposed to combine oat and pea proteins as a practical alternative to soy and gluten proteins for the production of meat analogues (Kaleda et al. 2021. Physicochemical, textural, and sensorial properties of fibrous meat analogues from oat-pea protein blends extruded at different moistures, temperatures, and screw speeds. Future Foods 4(2021) 100092). US patent publication 4,143,164 discloses the use of plant-based unsaturated fat in order to obtain a bacon analog. Biosurfactant-based emulsions have also been proposed to produce 3D-printed food. According to this study, the replacement of oil by biopolymeric surfactants is recommended to produce a fibrous 3D-printed reduced-fat meat analogue, in which the printed reduced-fat constructs presented the desired sensory profile (Shahbazi et al. 2021. Construction of 3D printed reduced-fat meat analogue by emulsion gels. Part II: Printing performance, thermal, tribological, and dynamic sensory characterization of printed objects. Food Hydrocolloids 121 (2021) 107054). However, for many meat analogues a satisfying flavour-rich fat is still missing from the product. A combination of biopolymeric surfactants and hydrocolloids does not mimic the full suite of organoleptic properties characteristic of animal-derived meats, i.e. both texture and taste.

This difficulty is particularly significant for high-fat food matrices (e.g. fatty matrices) such as “foie gras” which comprises a majority proportion of fat and has a sophisticated flavour. Foie gras is a specialty food product made of the liver of a duck or goose fattened by force-feeding, or ‘gavage’. Ducks are force-fed twice a day for 12.5 days and geese three times a day for around 17 days. Ducks are typically slaughtered at 100 days and geese at 112 days. Unlike natural fattening, which is authorised everywhere in the world, force-feeding is increasingly becoming prohibited, either under general animal protection laws or because of specific prohibitions. In particular, it is prohibited in Argentina, California (United States), Israel, Norway, Switzerland, Turkey, as well as in most countries of the European Union, where it is now only practised in five countries (France, Hungary, Bulgaria, Spain and Belgium). Fatty liver is a highly specific food product having a very particular texture, taste and appearance, with a marked difference between force-feeding (conventional system) and spontaneous fattening (alternative system). In the conventional system, the liver composition comprises 67.2% dry matter, 56.6% lipids, 6.1% proteins, in opposition to the alternative system wherein the liver composition comprises 63.9% dry matter, 53.2% lipids, 6.5% proteins. In addition, the lipid composition of the livers is drastically different: livers from the alternative system contain significantly fewer triglycerides and free fatty acids. Although the differences are of low magnitude (−0.4 and −0.12 points, respectively), the proportion of mono- and polyunsaturated fatty acids is significantly higher in livers from the alternative group, which in turn results in a significantly lower proportion of saturated fatty acids. The spontaneously fattened livers differ from force-feeding fattened livers for the sensory indicators related to the visual aspect, texture, bitterness and flavour intensity (Fernandez X. et al, Comparison of the composition and sensory characteristics of goose fatty liver obtained by overfeeding and spontaneous feeding, Poultry science, 2019, p 6149-6160). Replicating the physicochemical and sensory qualities of meat in analogues is not trivial (Samard & Ryu, 2019, A comparison of physicochemical characteristics, texture, and structure of meat analogue and meats. Journal of the Science of Food and Agriculture, 99(6), 2708-2715) and this is especially true when there is already difference in physicochemical and sensory qualities of meat according to breeding protocols. All of these parameters make the reproduction of taste and texture of animal flesh by ex vivo systems extremely complex.

Hence, there are important needs to find an alternative to animal slaughtering and intensive production means such as force-feeding to produce an edible food product which has a pleasant flavour, texture and cooking behaviour as expected for meat. In particular, there is a need for meat analogues to mimic the expected texture, in particular an expected texture of the animal fat, to enable the consumer to cook the product in the same manner as conventional meat and to experience the same final texture over a wide temperature range.

### SUMMARY OF THE INVENTION

The following sets forth a simplified summary of selected aspects, embodiments and examples of the present invention for the purpose of providing a basic understanding of the invention. However, this summary does not constitute an extensive overview of all the aspects, embodiments and examples of the invention. Its sole purpose is to present selected aspects, embodiments and examples of the invention in a concise form as an introduction to the more detailed description of the aspects, embodiments and examples of the invention that follow the summary.

The invention aims to overcome the disadvantages of the prior art. In particular, the invention proposes an edible food product comprising a fatty matrix, said fatty matrix comprising more than 40.00% of plant fat and/or fermented fat in weight with respect to a total weight of fatty matrix, said fatty matrix comprising triglycerides, said triglycerides comprising:
1 more than 40% in weight of unsaturated C18 fatty acids with less than four carbon-carbon double bonds, with respect to a total weight of said triglycerides,
more than 2% in weight of polyunsaturated C18 fatty acids, with respect to a total weight of said triglycerides,
   said fatty matrix further comprising more than 2.10% of proteins in weight with respect to the total weight of the fatty matrix, said proteins including non-human animal proteins.

Such an edible product has a texture similar to meat (e.g. it can have a texture similar to foie gras). In particular, the fatty matrix has a texture similar to the fatty phase of meat when tasting over a wide range of temperatures. Hence, the fatty matrix has a texture before cooking, while cooking and after cooking similar to the fatty phase of meat. Moreover, the fatty matrix may have a meaty flavour. The edible product according to the invention can be thus considered as an alternative to a conventional meat product.

Such an edible product can be processed to mimic a large variety of products such as foie gras, a highly marbled meat, a fatty fish flesh such as salmon flesh or a product of a mainly vegetable/fungal origin with a fatty phase that sticks to fibres and has a meaty flavour.

Moreover, as it will be described hereafter, when the fatty matrix comprises duck and/or goose proteins, it allows the production of an edible product with a foie gras texture and flavour while avoiding the slaughtering and/or force-feeding of ducks or geese. Hence, in some aspect, the invention allows the production of a foie gras from raw materials which are produced in accordance with animal welfare, in particular without force-feeding of animals, and which is of high-quality in flavour (taste and aroma) and consistency and, preferably, of which olfactory, gustatory and tactile characteristics (flavour) felt on tasting are similar to those felt on tasting foie gras obtained by force-feeding.

According to other optional features of the edible food product according to the invention, it can optionally include one or more of the following characteristics alone or in combination:
the animal proteins are selected among Mammalia proteins, Aves proteins, Actinopterygii proteins, Malacostraca proteins, and combination thereof. In particular, the fatty matrix comprising at least 1% in weight of non-human animal proteins with respect to the total weight of the fatty matrix and said non-human animal proteins are selected among Mammalia proteins, Aves proteins, Actinopterygii proteins, Malacostraca proteins, and combination thereof. For example, Mammalia proteins can be Bovidae proteins, Cervidae proteins, Leporidae proteins or Suidae proteins; Aves proteins can be Anatidae proteins or Phasianidae proteins; Actinopterygii proteins can be Gadidae proteins, Merlucciidae proteins, Pleuronectidae proteins, Salmonidae proteins, or Scombridae proteins; and Malacostraca proteins can be Palaemonidae proteins.
the animal proteins are derived from cultivated animal cells; for example, the animal cells are selected among stem cells such as induced pluripotent stem cells, germ layers cells, fibro-adipogenic progenitors, muscle cells, hepatocytes, fibroblasts, adipocytes, chondrocytes, keratinocytes, and combination thereof. Alternatively, the animal proteins are derived from animal flesh; for example, the animal flesh is selected among muscle, skin, offal such as liver, and combination thereof.
the plant fat and/or fermented fat comprises at least 50% in weight of triglycerides with respect to the total weight of the plant fat and/or fermented fat. Preferably, the fatty matrix comprises at least 25% in wet weight of triglycerides, more preferably at least 40% in wet weight of triglycerides, even more preferably at least 50% in wet weight of triglycerides, for example at least 60% in wet weight of triglycerides. Indeed, the presence of triglycerides is involved in obtaining a more appreciated meat-like texture.
the unsaturated C18 fatty acids with less than four carbon-carbon double bonds are selected from: oleic acid, linoleic acid, linolenic acid and combination thereof. The linolenic acid can be gamma linolenic acid, alpha linolenic acid or a mixture thereof.
the fatty matrix comprises less than 60% in weight of saturated C16-C18 fatty acid with respect to a total weight of said fatty matrix triglycerides.
the fatty matrix comprises less than 30% in weight of stearic acid with respect to a total weight of said fatty matrix triglycerides.
the fatty matrix comprises at most 35.00% in weight of palmitic acids with respect to a total weight of said fatty matrix triglycerides.
the fatty matrix comprises at least 4.00% in weight of stearic acid with respect to a total weight of said fatty matrix triglycerides. The presence of stearic acid seems to participate in obtaining a more appreciated meat-like texture.
the fatty matrix comprises at least 0.01% in weight of linolenic acid with respect to a total weight of said fatty matrix triglycerides. The 0.01% in weight of linolenic acid can be at least 0.01% in weight of gamma linolenic acid, at least 0.01% in weight of alpha linolenic acid or at least 0.01% in weight of a mixture thereof. The presence of linolenic acid seems to participate in obtaining a more appreciated meat-like texture.
the fatty matrix comprises more than 40.00% in weight of oleic acid with respect to a total weight of said fatty matrix triglycerides. The presence of high concentration of oleic acid seems to participate in obtaining a more appreciated meat-like texture.
it further comprises a protein matrix, a carbohydrate matrix, a plant matrix and/or a fibrous matrix in contact with the fatty matrix, preferably the fibrous matrix is a plant-based fibrous matrix, a fungal-based fibrous matrix, a bacterial-based fibrous matrix or a cultured animal cells based fibrous matrix.
it comprises at least 10% in weight of the fatty matrix with respect to the total weight of the edible food product.
it is a foie gras substitute, a marbled-meat substitute, a fish flesh substitute such as salmon flesh or tuna flesh.
its fat release properties are such that, during pan frying at a surface temperature of 180° C. for 60 seconds per side, it releases at most 30% in weight of fat with respect to the total weight of the edible food product. Alternatively or in addition, Its fat release properties are such that, during a compression test, it releases at most 42% in weight of fat with respect to the total weight of the edible food product. Such fat release properties contribute to the fact that the edible product according to the invention can be considered as an alternative to a conventional meat product. Preferably, the sample used for the fat release measurement is a cylinder of 40 mm diameter and a height of 15 mm.
its hardness 1, at a temperature of 4° C., is of at least 40 N. Preferably, its hardness 1, for a cylinder of 20 mm diameter and a height of 20 mm, at a temperature of 4° C., is of at least 40 N. Such hardness 1 contributes to the fact that the edible product according to the invention can be considered as an alternative to a conventional meat product.
its hardness 2, at a temperature of 4° C., is of at least 25 N. Preferably, its hardness 2, for a cylinder of 20 mm diameter and a height of 20 mm, at a temperature of 4° C., is of at least 25 N. Such hardness 2 contributes to the fact that the edible product according to the invention can be considered as an alternative to a conventional meat product.
its cohesiveness, at a temperature of 4° C., is of at most 0.080. Preferably, its cohesiveness, for a cylinder of 20 mm diameter and a height of 20 mm, at a temperature of 4° C., is of at most 0.080. Such cohesiveness contributes to the fact that the edible product according to the invention can be considered as an alternative to a conventional meat product.

The invention also relates to a method of manufacture of an edible food product comprising a fatty matrix, the method comprising the steps of:
Providing plant fat and/or fermented fat, said plant fat and/or fermented fat comprising triglycerides, said triglycerides comprising:
   more than 40% in weight of unsaturated C18 fatty acids with less than four carbon-carbon double bonds, with respect to a total weight of said triglycerides,
   more than 2% in weight of polyunsaturated C18 fatty acids, with respect to a total weight of said triglycerides,
Providing proteins, including non-human animal proteins; and
Processing the said plant fat and/or fermented fat and the said proteins to produce an edible food product comprising a fatty matrix, said fatty matrix comprising:
   more than 40.00% of the said plant fat and/or fermented fat in weight with respect to a total weight of fatty matrix, and
   more than 2.10% of the said proteins in weight with respect to the total weight of the fatty matrix, said proteins including non-human animal proteins.

Such a method for the preparation of an edible food product is simple and sustainable compared to standard methods. In addition, such a method allows the production of an edible product having meat-like texture and organoleptic properties. The edible food product is thus an alternative to conventional meat products. In particular, edible food products can mimic the expected texture of the animal fat at low and high temperature and while cooking.

Hence, in some aspect, the invention allows the production of foie gras from raw materials produced in accordance with animal welfare criteria, in particular without force-feeding; said foie gras is of high quality in mouthfeel (texture) and preferably, olfactory, gustatory and tactile characteristics (flavour) felt while tasting it are similar to those of foie gras derived from force-feeding.

Preferably, the method further comprises a step of combining the fatty matrix with another food matrix, said food matrix being selected from a carbohydrate matrix, a protein matrix, a plant matrix and/or a fibrous matrix. The edible food product thus comprises this combination. Hence, the method can be used to produce an edible product mimicking complex meat-like structure while using a wide range of ingredients.

Further, the method according to the invention can comprise a step of homogenising the plant fat and/or fermented fat with the said proteins including non-human animal proteins.

### BRIEF DESCRIPTION OF THE DRAWINGS

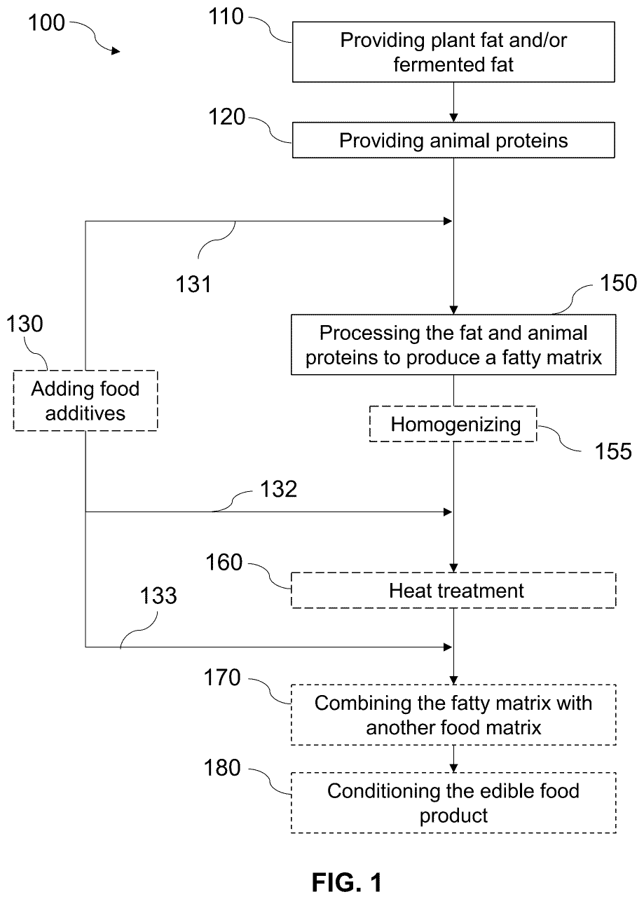

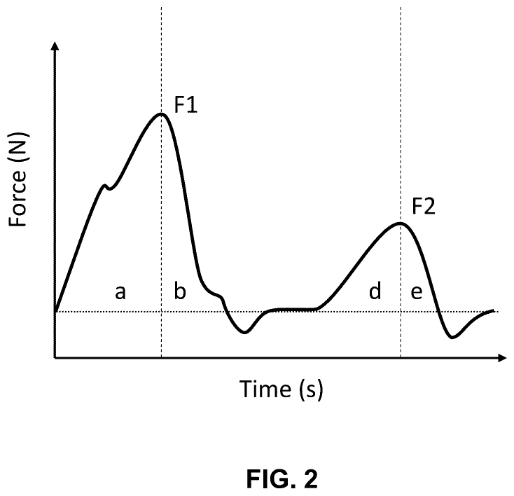

The foregoing and other objects, features and advantages of the present invention will become more apparent from the following detailed description when taken in conjunction with the accompanying drawings in which FIG. 1 is a schematic view of a method of producing an edible food product with meat-like texture according to an embodiment of the invention. The FIG. 2 is an illustration of the results generated during a Texture Profile Analysis.

Several aspects of the present invention are disclosed with reference to flow diagrams and/or block diagrams of methods and devices.

On the figure, the flow diagrams and/or block diagrams show the architecture, the functionality and possible implementation of devices or systems or methods, according to several embodiments of the invention.

In some implementations, the functions associated with the box may appear in a different order than indicated in the drawings. For example, two boxes successively shown, may be performed substantially simultaneously, or boxes may sometimes be performed in the reverse order, depending on the functionality involved.

### DETAILED DESCRIPTION

A description of example embodiments of the invention follows.

The expression “edible product” or “edible food product” as used herein can relate to a product suitable for animal consumption and preferably a product intended for human consumption. An edible product according to the invention can be a ready to eat (i.e finalised) food product or an intermediate in the production chain of a finalised food product. As it will be described hereafter, an edible product according to the invention can be produced in the form of a snack which may be pressed, fried and/or toasted; a sauce; a spread; a pasta; a paste; transformed-meat analogues or food specialty food such as sausage or cured sausage, paté or foie gras; a meat dough; a soup; a smoothie; a seafood; untransformed-meat analogues such as “flesh like” products.

In the following description, the term “meat” can refer to any edible part of an animal such as an animal tissue taken from a dead animal. Hence, a meat can refer to liver or other offal tissues, fat tissues, muscles tissues retrieved from a dead animal. The dead animal can refer to all species of the Animalia kingdom excluding human and preferably to all edible species such as a non-human vertebrate, for example, livestock, fish, birds; insects; a crustacean, for example a shrimp, prawn, crab, crayfish, and/or a lobster; a mollusk, for example an octopus, squid, cuttlefish, scallops, snail. Hence, for example, the invention allows the production of an edible product having meat-like texture such as a product mimicking foie gras, marbled beef, or salmon flesh.

As used herein, the expression “in weight” is generally referring to the weight of something compared to the weight of a food matrix such as the fatty matrix or the edible product, either the wet weight or the dried weight can be considered. Preferably, percentages are disclosed in reference to the wet weight.

As used herein, “flavour” is generally the quality of the product that affects the sense of taste and/or the aroma. Hence, a “meat-like flavour” can refer to a flavour which is close to, or which approximates, the flavour of the related conventional meat product.

As used herein, “texture” can be considered as the ‘combination of the rheological and structural (geometrical and surface) attributes of a food product perceptible by means of mechanical, tactile, and where appropriate, visual and auditory receptors’ as defined in 2008 by the International Standards Organization (ISO, 2008, Sensory analysis-vocabular, Vols. 1-107, p. 5492). Hence, a “meat-like texture” can refer to the rheological and structural (geometrical and surface) attributes of a food product which is close to, or which approximates, the texture of the related conventional meat product (i.e. a meat product derived from animal breeding and/or slaughtering). An edible food product according to the invention with a meat-like texture and a meat-like flavour can be considered as an alternative to a meat product.

As used herein, the expression “core temperature” can be considered as referring to the temperature measured substantially in the middle of the edible food product. It can, for example, be measured with a penetration thermometer.

As used herein, “food matrix” can relate to a matrix, wet or dried, suitable for human consumption. A food matrix is constituted mainly of lipids, proteins and/or carbohydrates. A food matrix can be a fatty matrix, a protein matrix, a carbohydrate matrix or a mix thereof. A food matrix can comprise cultured cells as defined below or an extract thereof. When a composition is referring to a weight of the food matrix, such as a fatty matrix or a protein matrix, either the wet weight or the dried weight can be considered. Preferably, percentages are disclosed in reference to the wet weight. The relative moisture content of a wet food matrix can be of 10% or over. For example, the relative moisture of a wet food matrix can range from 20% to 95%. Preferably, the moisture content of a wet food matrix can range from 30% to 80%. A food matrix can comprise plant material obtained from edible plants, including the flowers, fruits, stems, leaves, roots, and seeds. For example, a food matrix, such as a fatty matrix, a protein matrix, or a carbohydrate matrix can comprise at least 20% in weight of plant material, preferably at least 30% in weight of plant material, more preferably 40% in weight of plant material, even more preferably 50% in weight of plant material.

As used herein, “fatty matrix” can relate to a matrix suitable for human consumption. Preferably, a fatty matrix is constituted mainly of lipids. For example, a fatty matrix comprises at least 50% in weight of lipids, preferably at least 60% in weight of lipids, more preferably 70% in weight of lipids, even more preferably 80% in weight of lipids.

As used herein, “protein matrix” can relate to a matrix, wet or dried, suitable for human consumption. Preferably, a protein matrix, when dried, is constituted mainly of protein. For example, a protein matrix comprises at least 50% in weight of protein, preferably at least 60% in weight of protein, more preferably 70% in weight of protein, even more preferably 80% in weight of protein with respect to a total dry weight of the protein matrix.

As used herein, “carbohydrate matrix” can relate to a matrix, wet or dried, suitable for human consumption. Preferably, a carbohydrate matrix is constituted mainly of carbohydrates. For example, a carbohydrate matrix comprises at least 50% in weight of carbohydrate, preferably at least 60% in weight of carbohydrate, more preferably 70% in weight of carbohydrate, even more preferably 80% in weight of carbohydrate.

As used herein, “plant matrix” can relate to a matrix, wet or dried, suitable for human consumption. Preferably, a plant matrix is constituted mainly from plant material. Said plant material refers to any edible plant matter development stage or part, including the flowers, fruits, stems, leaves, roots, germ and seeds. For example, a plant matrix comprises at least 50% in weight of plant material, preferably at least 60% in weight of plant material, more preferably 70% in weight of plant material, even more preferably 80% in weight of plant material.

As used herein, the expressions “cultivated cells” or “cultured cells” are used interchangeably. They can refer to cells multiplied, preferably in a controlled environment, using a culture medium. It refers in particular to cells with a growth controlled by mankind, for example in an industrial process, as opposed to cells from conventional meat that have been multiplied in a living organism or cells grown in a natural environment (e.g. forest grown mushrooms). Cultivated cells can refer to cells belonging to Animalia kingdom but also to Bacteria and Fungi kingdoms. Hence, a food matrix can refer to a cultivated cell-based matrix. Cultivated cells can be cultured from cells of any origin such as cells from biopsies. They can originate from a biopsy sample, derived from stem cells or correspond to stem cells themselves. More particularly, a cultivated cells-based protein matrix can refer to a protein matrix which is constituted mainly of protein from cultivated cells. For example, a cultivated cells-based protein matrix comprises at least 50% in weight of protein from cultivated cells, preferably at least 60% in weight of protein from cultivated cells, more preferably 70% in weight of protein, even more preferably 80% in weight of protein from cultivated cells.

As used herein, the expression “extracts of cultivated cells” can refer to any fraction of disrupted cells or to any biological material purified or partially purified recovered from disrupted cells. Disrupted cells can be cells having partially or completely destroyed cell walls. In a food matrix, extracts of cultivated cells can comprise both disrupted cells and/or biological material recovered from disrupted cells.

As used herein, the terms “improved” or “optimised” refer to qualities equal or greater than those of a product obtained by animal slaughtering or animal force-feeding.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or even more.

As mentioned, the production of tasty meat-like products without animal slaughtering, or for foie gras without force-feeding, is a challenge for both animal welfare and the environment. In addition to animal welfare or environmental protection, it appears necessary to produce a food product which corresponds to the expectations of consumers by exhibiting qualities close to those of a conventional product with, in particular, a texture similar to meat.

A new method has been developed for producing a new edible product having meat-like texture without comprising tissues from a slaughtered animal. The invention also encompasses an edible product mimicking foie gras, which does not comprise hepatocytes obtained from a force-fed animal.

In particular, the answer which has been developed allows the production of an edible product comprising a fatty matrix with a texture which is greatly improved over a wide range of temperatures.

Hence, according to a first aspect, the invention relates to an edible food product comprising a fatty matrix according to the invention.

Advantageously, the edible food product according to the invention can be considered as an alternative to conventional meat products. An edible food product can for example be a ready to eat food product that can be consumed directly, or eventually after a cooking and/or processing step (e.g. crushing, squishing, cutting, grinding, mixing, shredding, squeezing, dosing, moulding, pressing, 3D printing, extruding baking or cooking steps such as smoking, roasting, frying, surface treatment, and/or coating). An edible food product can also be an intermediate product that will be used in combination with other products to produce a ready to eat food product. In particular, the edible food product can be an alternative product to the meat which aims to imitate a known meat product (e.g. steak, sausage, pâté . . . ). As it will be illustrated in examples, an edible food product according to the invention can exhibit a meat-like texture compared to an edible food product which does not comprise a fatty matrix according to the invention. This meat-like structure concerns in particular the fatty matrix part of the edible food product.

As mentioned, an edible product can correspond to an ingredient for use in the preparation of a ready to eat food product. For example, an edible product according to the invention can be in the form of a liquid (e.g. suspension, solution or emulsion), granulate or powder which can be used in the preparation of a ready to eat food product such as an alternative to a meat product.

The edible food product according to the invention will preferably be a processed food product. Indeed, it will not consist in animal flesh as such and will preferably result from a combination of edible substances from different source organisms (e.g. an hybrid product combining proteins from Animalia kingdom and fat from Plant kingdom).

As the conventional meat product, an edible food product according to the invention can comprise one or several separate matrices. At least, the edible food product according to the invention will comprise at least one fatty matrix. A fatty matrix can be considered as a food matrix which contains a majority in weight of fat.

The fatty matrix comprises more than 40.00% of plant fat and/or fermented fat in weight with respect to a total wet weight of fatty matrix. For example, the fatty matrix can comprise at least 50% of plant fat and/or fermented fat in weight with respect to a total weight of fatty matrix. Preferably, the fatty matrix comprises at least 55%, more preferably at least 60%, even more preferably at least 65%, such as at least 70% of plant fat and/or fermented fat in weight with respect to a total weight of fatty matrix (e.g. wet weight). It should be understood that when the fat matrix contains plant fat and fermented fat, then the percentages mentioned above refer to the combined percentage in weight of plant and fermented fat. Preferably said fat is a plant fat or a mixture of fat from different plants. However, as will be specified later, the fatty phase does not only include plant fat and/or fermented fat. It can include fat of other origins and ingredients other than fat. Hence, the fatty matrix can comprise at most 95% of plant fat and/or fermented fat in weight with respect to a total weight of fatty matrix. Preferably, the fatty matrix comprises at most 90%, more preferably at most 85%, even more preferably at most 80%, of plant fat and/or fermented fat in weight with respect to a total weight of fatty matrix (e.g. wet weight).

The fatty matrix according to the invention can be characterised by its ability to adequately mimic a meaty fat phase. In particular, as it will be mentioned in the example section, the fatty matrix can have a hardness at cooking temperature which is substantially equal to the hardness of the lipid phase of conventional meat at this cooking temperature.

The edible food product may have better meat similarity properties depending on the amount of saturated and unsaturated fatty acids. For example, the fatty matrix comprises a ratio in weight of unsaturated C18 fatty acids on saturated C16-C18 fatty acids of at least 0.80, preferably at least 1.00, more preferably at least 1.20, even more preferably at least 1.50. For example, the fatty matrix comprises a ratio in weight of unsaturated C18 fatty acids on saturated C16-C18 fatty acids ranging from 0.8 to 5, more preferably ranging from 0.8 to 4, more preferably ranging from 1.00 to 3, even more preferably a ratio in weight between unsaturated C18 fatty acids and saturated C16-C18 fatty acids ranging from 1.50 to 2.50.

Unsaturated fatty acids can be selected among monounsaturated fatty acids and polyunsaturated fatty acids. Hence, unsaturated C18 fatty acids with less than four carbon-carbon double bonds can be selected among oleic acid, linoleic acid, linolenic acid, and a combination thereof. Polyunsaturated C18 fatty acids can be selected among linoleic acid, linolenic acid and a combination thereof. It should be understood that when unsaturated fatty acid amounts are mentioned, they include monounsaturated fatty acids amounts and polyunsaturated fatty acids.

Preferably, the unsaturated fatty acids and saturated fatty acids in the fatty matrix can be measured using gas chromatography coupled with a flame ionisation detector. The fatty acids are typically converted to fatty acid methyl esters (FAMEs) which are more easily separated and thus quantified than their original form within triglycerides or as free fatty acids. In particular, it can be measured following the instructions detailed in the norm ISO 12966.

Moreover, the fatty acids can be free or present in the form of glycerides, such as monoglycerides, diglycerides or triglycerides. As it will be detailed hereafter, the fatty acids are preferably mainly present in the form of triglycerides. As it will be described, the plant fat and/or fermented fat comprise triglycerides. Moreover, fatty acids, fatty acid composition and in particular fatty acids ratio described above can refer to fatty acids in the form of triglycerides.

Preferably, most of the plant fat and/or fermented fat found in the fatty matrix are present in the form of triglycerides. Hence, the fatty matrix can comprise at least 50% in weight of triglycerides with respect to a total weight of fat in the fatty matrix, preferably at least 70% in weight of triglycerides with respect to a total weight of fat in the fatty matrix, more preferably at least 80% in weight of triglycerides with respect to a total weight of fat in the fatty matrix, even more preferably at least 90% such as at least 95% in weight of fats are triglycerides with respect to a total weight of fat in the fatty matrix. In an embodiment, these triglycerides can come from the plant and/or fermented fat but also from cultivated cells added to the fatty matrix.

In particular, and as it will be shown in examples, the relative quantities of unsaturated C18 fatty acids such oleic acid, linoleic acid, linolenic acid; and saturated C16-C18 fatty acids such as stearic acid and palmitic acid in the fatty matrix are important to obtain a texture as close as possible to the texture of a meat product.

The problem is solved when a high portion of unsaturated C18 fatty acids (e.g. with less than four carbon-carbon double bonds), preferably in the form of triglycerides, in an edible product of the invention. Hence, in particular, as it will be shown in examples, the triglycerides of the fatty matrix comprise more than 40% in weight of unsaturated C18 fatty acids with less than four carbon-carbon double bonds with respect to the total weight of triglycerides in the fatty matrix. Preferably, the triglycerides of the fatty matrix comprise more than 45% in weight of unsaturated C18 fatty acids with less than four carbon-carbon double bonds with respect to the total weight of triglycerides in the fatty matrix. More preferably, the triglycerides of the fatty matrix comprise more than 50% in weight of unsaturated C18 fatty acids with less than four carbon-carbon double bonds with respect to the total weight of triglycerides of the fatty matrix. Even more preferably, the triglycerides comprise more than 55% in weight of unsaturated C18 fatty acids with less than four carbon-carbon double bonds with respect to the total weight of triglycerides in the fatty matrix.

As detailed in the examples, the edible product of the invention should also comprise a minimal concentration of polyunsaturated C18 fatty acids, preferably in the form of triglycerides. Hence, in particular, as it will be shown in examples, the triglycerides of the fatty matrix comprise more than 2% in weight of polyunsaturated C18 fatty acids with respect to the total weight of triglycerides in the fatty matrix. Preferably, the triglycerides of the fatty matrix comprise more than 2.5% in weight of polyunsaturated C18 fatty acids with respect to the total weight of triglycerides in the fatty matrix. More preferably, the triglycerides of the fatty matrix comprise more than 3.5% in weight of polyunsaturated C18 fatty acids with respect to the total weight of triglycerides of the fatty matrix. Even more preferably, the triglycerides comprise at least 7% in weight of polyunsaturated C18 fatty acids with respect to the total weight of triglycerides in the fatty matrix. In particular, the edible product of the invention preferably comprises a minimal concentration of linolenic acids, preferably in the form of triglycerides. Hence, in particular, as it will be shown in examples, the triglycerides of the fatty matrix comprise linolenic acids for example more than 0.01% in weight of linolenic acids with respect to the total weight of triglycerides in the fatty matrix. Preferably, the triglycerides of the fatty matrix comprise more than 0.10% in weight of linolenic acids with respect to the total weight of triglycerides in the fatty matrix. More preferably, the triglycerides of the fatty matrix comprise at least 1% in weight of linolenic acids with respect to the total weight of triglycerides of the fatty matrix. Even more preferably, the triglycerides comprise at least 2% in weight of linolenic acids with respect to the total weight of triglycerides in the fatty matrix.

Similarly, it has been found that presence of stearic acid in the triglycerides is beneficial to the needs solved by the invention. Hence, in particular, as it will be shown in examples, the triglycerides of the fatty matrix comprise at least 4% in weight of stearic acid with respect to the total weight of triglycerides in the fatty matrix. Preferably, the triglycerides of the fatty matrix comprise at least 5% in weight of stearic acid with respect to the total weight of triglycerides in the fatty matrix. More preferably, the triglycerides of the fatty matrix comprise at least 10% in weight of stearic acid with respect to the total weight of triglycerides of the fatty matrix. Even more preferably, the triglycerides comprise at least 15% in weight of stearic acid with respect to the total weight of triglycerides in the fatty matrix. However, an excessive portion of stearic acid in the triglycerides of the fatty matrix can be detrimental to the needs solved by the invention. In preferred embodiments, the triglycerides of the fatty matrix comprise less than 40% in weight of stearic acid with respect to the total weight of triglycerides in the fatty matrix. Preferably, the triglycerides of the fatty matrix comprise more than 30% in weight of stearic acid with respect to the total weight of triglycerides in the fatty matrix. More preferably, the triglycerides of the fatty matrix comprise more than 20% in weight of stearic acid with respect to the total weight of triglycerides of the fatty matrix.

As it will be illustrated in example, an excessive amount of saturated C16-C18 fatty acid with respect to a total weight of plant and/or fermented fat triglycerides can be detrimental to the needs solved by the invention. Hence, for example, the fatty matrix comprises less than 60% in weight of saturated C16-C18 fatty acid with respect to a total weight of plant and/or fermented fat triglycerides; preferably less than 50% in weight of saturated C16-C18 fatty acid with respect to a total weight of plant and/or fermented fat triglycerides; more preferably less than 40% in weight of saturated C16-C18 fatty acid with respect to a total weight of plant and/or fermented fat triglycerides; even more preferably less than 30% in weight of saturated C16-C18 fatty acid with respect to a total weight of plant and/or fermented fat triglycerides.

It has been discovered that an excessive portion of palmitic acid in the triglycerides of the fatty matrix can be detrimental to the needs solved by the invention. Hence, in particular, as it is shown in examples, the triglycerides of the fatty matrix comprise less than 59.00% in weight of palmitic acid with respect to the total weight of triglycerides in the fatty matrix. Preferably, the triglycerides of the fatty matrix comprise less than 50% in weight of palmitic acid with respect to the total weight of triglycerides in the fatty matrix. More preferably, the triglycerides of the fatty matrix comprise less than 40% in weight of palmitic acid with respect to the total weight of triglycerides in the fatty matrix. Even more preferably, the triglycerides of the fatty matrix comprise at most 35.00% in weight of palmitic acid with respect to the total weight of triglycerides in the fatty matrix.

On the contrary, a high proportion of oleic acid in the triglycerides is found beneficial to the needs solved by the invention. Hence, in particular, as it will be shown in examples, the triglycerides of the fatty matrix comprise more than 33.00% in weight of oleic acid with respect to the total weight of triglycerides in the fatty matrix. Preferably, the triglycerides of the fatty matrix comprise more than 35% in weight of oleic acid with respect to the total weight of triglycerides in the fatty matrix. More preferably, the triglycerides of the fatty matrix comprise more than 40% in weight of oleic acid with respect to the total weight of triglycerides of the fatty matrix. Even more preferably, the triglycerides comprise more than 45% in weight of oleic acid with respect to the total weight of triglycerides in the fatty matrix.

As mentioned, the weight of total oleic acid, palmitic acid and stearic acid in the fatty matrix (free, as well as contained in monoglycerides, diglycerides and triglycerides) can be measured by converting the free fatty acids monoglycerides, diglycerides and triglycerides into fatty acid methyl esters and to quantify them using gas chromatography coupled with flame ionisation detector or with mass spectrometer. For example, this can be done through the norm ISO 12966. Hence, the person skilled in the art can easily calculate the portion in weight of oleic acid, palmitic acid and stearic acid in the triglycerides.

In particular, as it will be shown in examples, the triglycerides in the fatty matrix can comprise:
less than 50% in weight of palmitic acid with respect to the total weight of the fatty matrix triglycerides,
more than 35% in weight of oleic acid with respect to the total weight of the fatty matrix triglycerides, and
at least 2% in weight of linoleic acid with respect to the total weight of the fatty matrix triglycerides.

Preferably, as it will be shown in examples, the triglycerides in the fatty matrix comprise:
less than 50% in weight of palmitic acid with respect to the total weight of the fatty matrix triglycerides,
at least 4% in weight of stearic acid with respect to the total weight of the fatty matrix triglycerides,
more than 35% in weight of oleic acid with respect to the total weight of the fatty matrix triglycerides, and
at least 2% in weight of linoleic acid with respect to the total weight of the fatty matrix triglycerides.

More preferably, as it will be shown in examples, the triglycerides in the fatty matrix comprise:
less than 50% in weight of palmitic acid with respect to the total weight of the fatty matrix triglycerides,
at least 4% in weight of stearic acid with respect to the total weight of the fatty matrix triglycerides,
more than 35% in weight of oleic acid with respect to the total weight of the fatty matrix triglycerides,
more than 5% in weight of linoleic acid with respect to the total weight of the fatty matrix triglycerides, and
more than 0.01% in weight of linolenic acid with respect to the total weight of the fatty matrix triglycerides.

The fatty matrix can only comprise plant fat or can only comprise fermented fat or can comprise a combination of plant fat and fermented fat. Moreover, the plant fat and/or fermented fat can be completed with other fats. Indeed, as the fatty matrix comprises animal proteins which can come from animal cultured cells, the fatty matrix can comprise animal cell triglycerides. Alternatively, the fats of the fatty matrix are exclusively selected from plant fat and/or fermented fat. Also, the fats of the fatty matrix can be obtained from fractionated oil and/or hydrogenated oil and/or deodorised oil and/or interesterified oil.

The plant fat can for example comprise fat or oil extracted from edible plant matter, including the flowers, fruits, stems, leaves, roots, germs and seeds. Preferably, the plant fat can for example comprise fat or oil extracted from oilseeds or fruits. In particular, the plant fat can relate to fat extracted from canola seed (rapeseed), castor, coconut, flaxseed, allanblackia, olive, sunflower, soybean, peanut, illipe, cottonseed, shea, palm, avocado, safflower, sesame, lemon, grapeseed, macadamia, almond, sal, kokum, or mango or a combination thereof.

In particular, the plant fat used according to the invention can be selected from olive oil, palm oil, avocado oil, almond oil or combination thereof.

The fermented fat can comprise fat or oil extracted from cells cultivated in anaerobic or aerobic fermentation process, in particular process involving cultivation of oleaginous microorganisms or animal cells excluding human cells. For example, the fermented fat can include fat from cyanobacteria, microalgae, yeast, fungi such as filamentous fungi, bacteria or cultivated animal cells excluding human cells, such as adipocytes. Preferably, the fermented fat comprises fat or oil extracted from oleaginous yeast, such as Rhodosporidium toruloides, Lipomyces starkeyi and Yarrowia lipolytica.

Moreover, beside the presence of fat, the fatty matrix according to the invention advantageously comprises proteins and in particular animal proteins excluding human proteins also called non-human animal proteins. Indeed, without being limited by the theory, the presence of proteins, in particular animal proteins, improves the ability of the fatty matrix to respond to the identified needs. For example, the inventors formulated the hypothesis that, in the specific fatty matrix of the invention, the proteins help in combination with a specific fat composition to produce a suitable mouthfeel, similar to the meat texture and in particular the fat phase texture of the meat. Moreover, the presence of animal proteins improves the organoleptic properties of the fatty matrix, especially the flavour.

Hence, as it will be shown in examples, the fatty matrix can further comprise more than 2.10% of proteins in weight with respect to the total weight of fatty matrix (e.g. wet weight). Preferably, the fatty matrix preferably further comprises more than 2.50% of proteins in weight with respect to the total weight of fatty matrix. More preferably, the fatty matrix preferably further comprises more than 3% of proteins in weight with respect to the total weight of fatty matrix. Even more preferably, the fatty matrix preferably further comprises more than 4% of proteins in weight with respect to the total weight of fatty matrix (e.g. wet weight). These proteins can be plant proteins, fungal proteins, bacterial proteins, fermented proteins, animal proteins and mixture thereof. However, as mentioned, said proteins advantageously include non-human animal proteins. Thus, among these more than 2.10% of proteins in weight with respect to the total weight of fatty matrix, there will be at least some of these proteins which will be non-human animal proteins. Advantageously, as it is illustrated in the examples, this can be implicated in the production of a meat analogue which could be confused with conventional meat in the context of a blind taste test, for example by improving the flavour of the edible product according to the invention.

Hence, as it will be shown in examples, the fatty matrix can further comprise at least 1% in weight of non-human animal proteins with respect to the total wet weight of the fatty matrix, preferably more than 2.10% of non-human animal proteins in weight with respect to the total weight of fatty matrix (e.g. wet weight). Preferably, the fatty matrix preferably further comprises more than 2.50% of non-human animal proteins in weight with respect to the total weight of fatty matrix. More preferably, the fatty matrix preferably further comprises more than 3% of non-human animal proteins in weight with respect to the total weight of fatty matrix. Even more preferably, the fatty matrix preferably further comprises more than 4% of non-human animal proteins in weight with respect to the total weight of fatty matrix (e.g. wet weight).

However, the fatty matrix preferably does not comprise a high quantity of proteins and in particular animal proteins. Hence, the fatty matrix can comprise less than 55% of proteins in weight with respect to the total weight of fatty matrix. Preferably, the fatty matrix preferably comprises less than 40% of proteins in weight with respect to the total weight of fatty matrix. More preferably, the fatty matrix preferably further comprises less than 30% of proteins in weight with respect to the total weight of fatty matrix. Even more preferably, the fatty matrix preferably further comprises less than 20% of proteins in weight with respect to the total weight of fatty matrix (e.g. wet weight). Among these proteins, the fatty matrix can comprise less than 40%, less than 30%; less than 20%, less than 15% of non-human animal proteins in weight with respect to the total weight of fatty matrix (e.g. wet weight).

Preferably, the fatty matrix further comprises from 2.5% to 55% in weight of proteins with respect to the total weight of fatty matrix. More preferably, the fatty matrix further comprises from 3% to 33% in weight of proteins with respect to the total weight of fatty matrix. Even more preferably, the fatty matrix further comprises from 4% to 25% in weight of proteins with respect to the total weight of fatty matrix (e.g. wet weight). Among these proteins, the fatty matrix can comprise from 1% to 30%, from 1% to 25%, from 1% to 20%, from 1% to 15%, or from 1% to 10%, of non-human animal proteins in weight with respect to the total weight of fatty matrix.

Preferably, the non-human animal proteins are selected among Bovidae proteins, Aves proteins, Suidae proteins, Leporidae proteins, Actinopterygii proteins, and combination thereof. More preferably, the non-human animal proteins are selected among duck proteins, goose proteins, beef proteins, pork proteins, tuna proteins, salmon proteins and combination thereof.

In an embodiment, the animal proteins can be derived from animal flesh, excluding human flesh. In particular, the animal flesh can be selected among muscle, offal such as liver, skin and combination thereof.

In an embodiment, the animal proteins can be derived from cultured animal cells, excluding human cells. For those who do not understand this meaning, the person skilled in the art knows that a duck protein is a protein produced by a duck cell, said duck cell may be cultured outside the duck organism. A duck cell belongs or is from an organism which belongs, by its ancestors, to a kingdom (Animalia), a family (Anatidae), a genus (Anas) or a species such as Anas platyrhynchos or Cairina moschata.

The animal cells can be selected among stem cells, fibroblasts, adipocytes, myocytes, keratinocytes, and combination thereof. Stem cells can refer to pluripotent or multipotent or totipotent cells, or to oligopotent stem cells of neurectoderm, mesoderm or endoderm lineage. Preferably, the animal cells are selected among cells derived from differentiation of non-human embryonic stem cells; cells derived from differentiation of non-human induced pluripotent stem cells; cells derived from transdifferentiated non-human isolated cells; immortalised mature non-human cells; and differentiated cells derived from differentiation of non-human progenitor cells.

### Cultured Cells

The problem of lack of flavour or an unsuitable texture can be prevalent for meat-like products, especially plant-based ones. Texture and flavour of cultured cells-based products can be improved as well. The invention is particularly adapted to edible products made at least partially from cultured cells. Hence, preferably, the fatty matrix comprises cultivated cells or cultivated cells extracts, said cultivated cells being cells belonging to an organism of the Animalia kingdom excluding human, of the Bacteria kingdom or of the Fungi kingdom, preferably said cultivated cells being cells belonging to an organism of the Animalia kingdom excluding human.

Hence, preferably, the edible product having meat-like texture according to the invention is obtained from cultivated cells. Such cultivated cells may have been kept intact or they may have been disrupted for example when homogenised, extruded, mixed, blended or subjected to melt blowing, electrospinning, centrifugal spinning, blow spinning. When the cultivated cells have been disrupted, the method according to the invention can comprise a step of extracting specific compounds after the disruption. For example, the method according to the invention can comprise a step of extracting the proteins and/or lipids (such as fatty acids or phospholipids) from the cultivated cells.

The fatty matrix can comprise animal cells excluding human cells, selected from: cells derived from differentiation of non-human embryonic stem cells; cells derived from differentiation of non-human induced pluripotent stem cells; cells derived from transdifferentiated non-human isolated cells; immortalised mature non-human cells; and differentiated cells derived from differentiation of non-human progenitor cells.

The fatty matrix can comprise hepatocytes excluding human hepatocytes, selected from: hepatocytes derived from differentiation of non-human embryonic stem cells; hepatocytes derived from differentiation of non-human induced pluripotent stem cells; hepatocytes derived from transdifferentiated non-human isolated cells; immortalised mature non-human hepatocytes; and differentiated hepatocytes derived from differentiation of non-human progenitor cells.

In particular, hepatocytes can be non-steatotic hepatocytes or steatotic hepatocytes.

The fatty matrix can comprise myocytes excluding human myocytes, for example selected from: myocytes derived from differentiation of non-human embryonic stem cells; myocytes derived from differentiation of non-human induced pluripotent stem cells; myocytes derived from transdifferentiated non-human isolated cells; immortalised mature non-human myocytes; and differentiated myocytes derived from differentiation of non-human progenitor cells.

### Differentiation of Non-Human Embryonic Stem Cells

Cells in the fatty matrix may be derived from differentiation of non-human embryonic stem cells. The differentiation comprises the sum of the processes whereby undifferentiated or unspecialized cells attain their function. Stem cells can be isolated from embryos and cultured using cultured media in order to achieve cellular proliferation and maintenance of the de-differentiated state. In an embodiment, the media formulations utilise synthetic serum-free media.

Next, the embryonic stem cells can be induced to differentiate for example into hepatocytes, fibroblasts, keratinocytes, myocytes or adipocytes. For example, for hepatocytes, non-human embryonic stem cells are induced into cells of the definitive endoderm, preferably with specific growth factors such as Activin A, WNT, FGF, or BMP; or other components having an effect on differentiation such as Insulin transferrin selenium, Rapamycin, KOSR, or Sodium butyrate. Next, cells of the final endoderm are specified into hepatic endoderm cells then hepatoblasts, preferably with specific factors as HGF, FGF, FGF and BMP. Hepatoblasts are differentiated into hepatocytes by differentiation induced with a combination of factors, preferably such as HGF, Oncostatin M, Dexamethasone and TGF-β. Next, the differentiated hepatocytes can be cultured and expanded to a desired quantity of cells.

### Differentiation of Non-Human Induced Pluripotent Stem Cells

Cells in the fatty matrix may be derived from differentiation of non-human induced pluripotent stem cells.

An episomal reprogramming strategy, for example of avian dermal fibroblasts isolated from goose, duck or chicken, can be employed to create induced pluripotent stem cells from the fibroblasts without the use of classic viral reprogramming techniques.

The induced pluripotent stem cells can be cultured using optimised media substrates and media formulations to achieve persistent cellular proliferation and maintenance of the de-differentiated state. The media formulations utilise synthetic serum-free media. Preferably, the cells are cultured in a pathogen-free cell culture system. Next, the pluripotent stem cells can be triggered to differentiate into hepatocytes and expanded to a desired quantity of cells.

### Transdifferentiated Non-Human Isolated Cells.

Cells in the fatty matrix may be derived from transdifferentiated non-human isolated cells. The transdifferentiation refers to the differentiation from one differentiated cell type to another differentiated cell type, preferably, in one step. The transdifferentiation can relates to a method that modifies the differentiated phenotype or developmental potential of a cell without the formation of a pluripotent intermediate cell; i.e. it does not require that the cell be first dedifferentiated (or reprogrammed) and then differentiated to another cell type. Instead, the cell type is merely “switched” from one cell type to another without going through a less differentiated phenotype. The transdifferentiation may also comprise a first step of submitting first cells having a first cell fate to conditions to generate second cells (i.e., a less differentiated cells) that are capable of differentiating into a second cell fate; and a second step of submitting the less differentiated cells to conditions to differentiate the cells into cells having the second cell fate, such as hepatocyte cells.

For example, non-human cells such as embryonic fibroblasts, embryonic stem cells, muscle cells are isolated using techniques known in the field of cell biology and are cultivated in a media comprising basal media, antibiotics, non-essential amino acids, reducing agents, serum, minerals and growth factors.

### Immortalised Mature Non-Human Hepatocytes

Cells in the fatty matrix may be selected from immortalised mature non-human hepatocytes. The specificity of the immortalised mature non-human hepatocytes lies in the fact that cells are able to divide indefinitely. Mature avian hepatocytes can be isolated from duck, goose or chicken liver. The hepatocytes can be immortalised using classical techniques such as transformation or spontaneous hepatocyte immortalization by sequentially passaging the hepatocytes until spontaneous mutations arise that result in immortalization. The immortalised hepatocytes can be expanded to a desired quantity of cells and grown in culture media.

Differentiated Cells Derived from Differentiation of Non-Human Progenitor Cells

Cells in the fatty matrix may be selected from differentiated hepatocytes derived from differentiation of non-human progenitor cells. The progenitor can be grown using optimised media substrates and media formulations in order to obtain a persistent cellular proliferation and maintenance of the pluripotent state. The media formulations may comprise synthetic serum-free media. Then, the hepatic stem cells are induced to differentiate into mature hepatocytes and expanded to a desired quantity of cells thanks to differentiation factors.

Advantageously, regardless of the origin of the hepatocytes, the cultivated hepatocytes can be considered as cells grown in a culture medium. Advantageously, the culture medium does not comprise foetal bovine serum. The culture medium may be supplemented, preferably gradually, in hydrolysate as plant or yeast. Such serum free medium allows to reduce and eliminate animal derived components.

Various media formulations are optionally used to enable the maintenance of the capacity for self-renewal such as during expansion of the cell population. As explained, the media formulations may be modified from conventional media to not require foetal bovine serum or animal alternatives to bovine serum. Rather, the medium may include plant or yeast hydrolysates. Examples of plant-based formulations include soybean-based and plant hydrolysate-based media formulations. Some media formulations may comprise at least one ingredient for enhancing the nutritional content of the cultured cells.

In addition, the media comprises all the components, and nutrients for the development of cells such as salt, glucose, water, salt minerals, and amino acids.

In an embodiment, the culture media may comprise scaffolds.

The cells are cultivated in incubators set up at 37° C., 5% of CO₂, at a pH of 7 and with moisture of at least 95%.

According to an embodiment of the invention the cultivated hepatocytes may be steatotic hepatocytes. Thus, the invention may comprise a step of inducing a steatosis in said cultivated hepatocytes.

According to an embodiment, the media may be supplemented with increasing concentrations of free fatty acids causing the hepatocytes to undergo steatosis by taking in and storing an excess amount of extracellular fatty acids.

Fatty acids may be selected from butyric acid, isobutyric acid, isovaleric acid, caproic acid, caprylic acid, pelargonic acid, capric acid, lauric acid, myristic acid, palmitic acid, oleic acid, docosahexaenoic acid, stearic acid, arachidic acid, linoleic acid, linolenic acid, arachidonic acid, palmitoleic acid and eicosapentaenoic acid or a mixture of thereof.

The length of time during which the cells are exposed to lipid concentrations sufficient to induce steatosis will vary depending on the cell type, size of the cell population, age of the cell population, number of passages, any genetic modification or manipulation of the cells, the type and components of the culture media, desired amount of lipid accumulation or steatosis, or any combination thereof.

For example, certain cell types will intake exogenous lipids from the culture media at a slower rate than other cell types, and thus require a longer incubation period in a lipid rich media to induce the desired amount of steatosis.

In many cases, cells are cultured in a culture media having a high lipid concentration for about 30 days to about 60 days.

According to another embodiment, the steatosis may be induced by the increased expression in the cell of the lipid pathway responsible for lipid metabolism and storage. In this case, the genetic manipulation results in the accumulation of lipid droplets within the cytoplasm of the hepatocytes, thereby resulting in steatosis. Expression of genes involved in lipid metabolism can be induced or enhanced to facilitate or enhance lipid accumulation and/or steatosis in target cells such as hepatocytes. According to an embodiment of the invention the hepatocytes in which steatosis is induced may be non-steatotic hepatocytes.

Proteins, and in particular animal proteins can be added to form the fatty matrix in any form compatible with the usual food processing methods. For example, the animal proteins can be added in the form of a protein containing solution such as a protein extract obtained from cells, in the form of cells or in the form of disrupted cells. Hence, the proteins used and in particular the non-human animal proteins can be obtained through fermentation by microorganisms such as bacteria and fungi as well as eukaryotic cells. As already mentioned, the proteins can be obtained from non-human animal cells, more preferably cultivated non-human animal cells.

An edible food product according to the invention can be constituted mostly of the fatty matrix, this can be the case when the edible food product according to the invention is a foie gras substitute. For example, the edible food product comprises at least 20% in weight of the fatty matrix with respect to the total weight of the edible food product. Preferably, the edible food product comprises at least 40% in weight of the fatty matrix with respect to the total weight of the edible food product. More preferably, the edible food product comprises at least 60% in weight of the fatty matrix with respect to the total weight of the edible food product. Even more preferably, the edible food product comprises at least 80% in weight of the fatty matrix with respect to the total weight of the edible food product. The edible food product could even be made up of more than 95% in weight of the fatty matrix with respect to the total weight of the edible food product.

However, an edible food product according to the invention can comprise a mix of a fatty matrix and another food matrix such as a protein matrix or a carbohydrate matrix. Hence, for some embodiments, the fatty matrix should not be the main constituent of the edible food product. For example, the edible food product comprises at most 80% in weight of the fatty matrix with respect to the total weight of the edible food product. Preferably, the edible food product comprises at most 60% in weight of the fatty matrix with respect to the total weight of edible food product. More preferably, the edible food product comprises at most 40% in weight of the fatty matrix with respect to the total weight of edible food product. Even more preferably, the edible food product comprises at most 20% in weight of the fatty matrix with respect to the total weight of edible food product. The edible food product could even be made up of less than 10% in weight of the fatty matrix with respect to the total weight of the edible food product.

In this context, a suitable binder can be used to provide an adhesion between matrices. In particular, emulsion gels, matrices composed of crosslinked protein or carbohydrate networks containing emulsified lipids, have been investigated. It has been proposed to use methylcellulose or ethyl cellulose to form oleogels. This is usually achieved by dispersing the derivatized cellulose molecule in oil at temperatures above its glass transition temperature and subsequently cooling the polymer solution below its gel point (Davidovich-Pinhas, Barbut, & Marangoni, 2014; 10.1007/s10570-014-0377-1). Similarly, matrices could be adhered by a protein isolate suspension such as a soy protein isolate suspension gelled by heating or transglutaminase addition (Herz E. et al, 2021; 10.1016/j.ifset.2021.102806). Hence, preferably, the fatty matrix further comprises a transglutaminase. More preferably, the fatty matrix can further comprise protein fibrils such as collagen or gelatin. Even more preferably, the fatty matrix comprises protein fibrils and transglutaminase.

As it has been described, the fatty matrix according to this invention can be considered as a texturizing fatty matrix. Thereby, the edible food product preferably comprises another food matrix, such as a protein matrix or a carbohydrate matrix in contact with the fatty matrix. For example, the edible food product can comprise a mixture of the fatty matrix and a protein matrix or a carbohydrate matrix. The edible food product can comprise a fatty matrix that is positioned above or below a protein matrix or a carbohydrate matrix.

In particular, the fatty matrix can act as a binder for a fibrous matrix such as a protein matrix or a carbohydrate matrix. Further to the organoleptic properties as outlined above, this binder can ensure the cohesion of the fibres of the fibrous matrix. Thereby, the edible food product preferably comprises a fibrous matrix in contact with the fatty matrix. For example, the fatty matrix can be positioned in the edible food product so as to cover the fibres or envelop the fibres or even engulf the fibres.

For example, the edible food product comprises at least 20% in weight of a fibrous matrix with respect to the total weight of the edible food product. Preferably, the edible food product comprises at least 40% in weight of a fibrous matrix with respect to the total weight of the edible food product. More preferably, the edible food product comprises at least 60% in weight of a fibrous matrix with respect to the total weight of the edible food product. Even more preferably, the edible food product comprises at least 80% in weight of a fibrous matrix with respect to the total weight of the edible food product.

A fibrous matrix can comprise fibrous structures which mimic muscle-meat type products. Such structures can be obtained through muscle fibre cultivation, use of mycoproteins, wet spinning, electrospinning, extrusion, freeze structuring, cells cultured on scaffolds, high-moisture extrusion, low-moisture extrusion, dry-spinning, wet-dry spinning, protein layering nutrient embedding technology, microextrusion or shear cell technology. The fibrous matrix can also be based on any kind of cellulose fibres/fibrils or amylose fibres/fibrils. The fibrous structures preferably have a length over a micrometre.

The fibrous matrix can be a plant-based fibrous matrix, a fungal-based fibrous matrix such as a yeast-based fibrous matrix, a bacterial-based fibrous matrix, an algae-based fibrous matrix or a cultured animal cell based fibrous matrix. Hence, the fibrous matrix can comprise plant-derived fibres, fungal-derived fibres such as yeast-derived fibres, bacterial-derived fibres, algae-derived fibres, cultured animal cells derived fibres or combination thereof.

The edible food product can comprise at least 20% in weight of a plant matrix with respect to the total weight of edible food product. Preferably, the edible food product comprises at least 40% in weight of a plant matrix with respect to the total weight of edible food product. More preferably, the edible food product comprises at least 60% in weight of a plant matrix with respect to the total weight of edible food product. Even more preferably, the edible food product comprises at least 80% in weight of a plant matrix with respect to the total weight of the edible food product.

As it has been mentioned, the edible food product can be a finished product or an ingredient for food processing. Preferably, the edible food product mimics an animal-derived edible food product. The edible food product can be a cooked, a non-cooked or a precooked product.

For example, the edible food product is a cooked edible food product or a pre-cooked edible food product. For example, the edible food product is precooked to be further pan-fried. Alternatively, the edible food product is a non-cooked product.

Hence, the edible food product can be packed in a flexible container such as a plastic sheet or rigid container such as a cylindrical or non-cylindrical jar. Advantageously, the edible food product can be a cooked edible food product. Hence, the edible food product can be packed in a jar, said jar being the same as the cooking jar.

### Physico-Chemical Properties of the Edible Food Product According to the Invention

### Fat Release Properties of an Edible Product Comprising a Fatty Matrix According to the Invention

One advantage of the invention is to mimic conventional food product cooking behaviour. The following fat release values during cooking can relate to the fat released during cooking for example during pan-frying the sample on a surface temperature of 180° C. during 60 seconds per side. Preferably, the sample used for the fat release measurement at cooking is a cylinder of 40 mm diameter and a height of 15 mm. The fat release value at cooking is preferably the mean value obtained from at least 5 independent samples. For example, fat release can be measured using a first paper napkin weighed, then used to collect and absorb the fat that leaked on the cooking surface after a cooking step. The difference of weight of the first paper napkin before and after pan-frying equals the weight of fat released during cooking.

The capacity of samples to release fat during cooking can be expressed in w/w % using the following equation:

$$( ( weight of fat absorbed by the first paper napkin after cooking ) \text{} / ( weight of sample before cooking ) ) * 100$$

Hence, an edible food product according to the invention can be formulated such that it releases, during cooking (such as pan-frying), at least 2% in weight of fat with respect to the total weight of the edible food product. Preferably, it can release at least 5% in weight of fat with respect to the total weight of the edible food product. More preferably, it can release at least 7.5% in weight of fat with respect to the total weight of the edible food product. Even more preferably, it can release at least 10% in weight of fat with respect to the total weight of the edible food product.

However, the fat released during cooking should not be too high. Hence, for example, an edible food product according to the invention can be formulated such that it releases, during cooking (such as pan-frying), at most 30% in weight of fat with respect to the total weight of the edible food product. Preferably, it can release at most 25% in weight of fat with respect to the total weight of the edible food product. More preferably, it can release at most 20% in weight of fat with respect to the total weight of the edible food product. Even more preferably, it can release at most 15% in weight of fat with respect to the total weight of the edible food product.

Hence, for example, an edible food product according to the invention can be formulated such that it releases, during cooking (such as pan-frying), from 2% to 30% in weight of fat with respect to the total weight of the edible food product, preferably 5% to 25% in weight of fat, more preferably from 7.5% to 20% in weight of fat, and even more preferably from 10% to 15% in weight of fat with respect to the total weight of the edible food product.

In particular, these fat release values during cooking can refer to the fat release values during cooking of the fatty matrix according to the invention with respect to the fatty matrix weight.

Fat release by an edible food product while it is chewed can also be a technical feature of interest when mimicking conventional food. The mechanical conditions of a typical chewing process can be reproduced by applying compression on the edible food product. Hence, the fat released during compression of the edible product is a technical feature relevant when mimicking conventional food.

The fat release during compression can be measured using the probe of a texture analyzer (or texturometer). The probe is set to drive to a limit of 0 mm at a speed of 100 mm/min for a duration of 30 seconds, in order to crush the samples once at 45° C. Preferably, the sample used for the fat release measurement during compression is a cylinder of 40 mm diameter and a height of 15 mm. The fat release value during compression is preferably the mean value obtained from at least 5 independent samples.

For example, each pan-fried sample is placed on a second paper napkin and under the probe of the texturometer. The difference of weight of the second paper napkin before and after compression equals the weight of fat released during compression.

The capacity of samples to release fat during compression (e.g. mimicking chewing) can be expressed in w/w % using the following equation:

$$( ( weight of fat absorbed by the second paper napkin after compression ) \text{} / ( weight of sample after cooking ) ) * 100$$

Advantageously, an edible food product according to the invention should have fat release properties during compression similar to those of conventional food. For example, an edible food product according to the invention can release, during compression, at least 2.5% in weight of fat with respect to the total weight of the edible food product. Preferably, it can release, during compression, at least 5% in weight of fat with respect to the total weight of the edible food product. More preferably, it can release, at compression, at least 10% in weight of fat with respect to the total weight of the edible food product. More preferably, it can release, during compression, at least 15% in weight of fat with respect to the total weight of the edible food product. Even more preferably, it can release, during compression, at least 20% in weight of fat with respect to the total weight of the edible food product.

Fat release during compression should not be too high. For example, an edible food product according to the invention can be formulated to release, during compression, at most 42% in weight of fat with respect to the total weight of the edible food product. Preferably, it can release, during compression, at most 40% in weight of fat with respect to the total weight of the edible food product. More preferably, it can release, during compression, at most 38% in weight of fat with respect to the total weight of the edible food product. Even more preferably, it can release, during compression, at most 36% in weight of fat with respect to the total weight of the edible food product.

Hence, for example, an edible food product according to the invention can be formulated such that it releases, during compression, from 2.5% to 42% in weight of fat with respect to the total weight of the edible food product, preferably 5% to 40% in weight of fat, more preferably from 10% to 38% in weight of fat, and even more preferably from 20% to 36% in weight of fat with respect to the total weight of the edible food product.

In particular, these fat release values during compression can refer to the fat release values during compression of the fatty matrix according to the invention with respect to the fatty matrix weight.

### Mechanical Properties of an Edible Product Comprising a Fatty Matrix According to the Invention

Also, the edible product according to the invention can be defined by its mechanical properties such as its hardness and its cohesiveness.

The hardness is a mechanical property of the food product which may reflect the force required by the consumer, while chewing, to compress a food product between the molars, or between the tongue and the palate. The hardness is preferably quantified (in Newton) using a texturometer paired with a compression plate probe. For instance, a Lloyd Instrument LS1SH-230V texturometer could be paired with a compression plate probe of 80 mm diameter using the Nexygen 3.0 Plus software to operate the system. The hardness test is based on multiple cycles of compression phase followed by a release phase, separated by a rest phase. For example, for the first cycle of compression, the probe goes down until 0.75*height of the sample at a speed of 60 mm/min. Then, the probe goes back to its initial position at a speed of 60 mm/min and holds for 60 seconds. The second cycle of compression is identical to the first one. The mechanical property values (hardness or cohesiveness) are preferably the mean value obtained from at least 5 independent samples.

The hardness is defined as the maximum force applied on the edible food product sample during the compression phase of the texture profile analysis (TPA) test, as explained in the example section. Briefly, as shown in FIG. 2, the TPA consists in applying two cycles of compression (a, d) of the sample under the probe, followed by a releasing phase (b, e), each cycle being separated by a rest phase (time between b and d), allowing the measurement of the hardness 1 and 2 (maximum of compression of each cycle) and the calculation of the cohesiveness of the sample. In FIG. 2, hardness 1 is identified by the peak of the first phase of compression and hardness 2 by the peak of the second phase of compression. The mechanical properties such as the hardness may vary depending on the temperature and the shape of the tested sample.

For example, for a cylinder of 20 mm diameter and a height of 20 mm, at a temperature of 4° C., an edible food product according to the invention has a hardness 1 of at least 40 N, preferably, at least 50 N, more preferably at least 55 N, and even more preferably at least 60 N.

For example, for a cylinder of 20 mm diameter and a height of 20 mm, at a temperature of 4° C., an edible food product according to the invention has a hardness 1 of at most 100 N, preferably, at most 95 N, more preferably at most 90 N, and even more preferably at most 85 N.

Hence, for example, for a cylinder of 20 mm diameter and a height of 20 mm, at a temperature of 4° C., an edible food product according to the invention has a hardness 1 from 40 N to 100 N, preferably from 50 N to 95 N, more preferably from 55 N to 90 N, and even more preferably from 60 N to 85 N.

In particular, these hardness 1 values can refer to the hardness 1 value of the fatty matrix according to the invention.

For example, for a cylinder of 40 mm diameter and a height of 15 mm, at a temperature of 45° C., an edible food product according to the invention has a hardness 1 of at least 12 N, preferably, at least 14 N, more preferably at least 16 N, and even more preferably at least 18 N.

For example, for a cylinder of 40 mm diameter and a height of 15 mm, at a temperature of 45° C., an edible food product according to the invention has a hardness 1 of at most 45 N, preferably, at most 40 N, more preferably at most 35 N, and even more preferably at most 30 N.

Hence, for example for a cylinder of 40 mm diameter and a height of 15 mm, at a temperature of 45° C., an edible food product according to the invention has a hardness 1 from 12 N to 45 N, preferably from 14 N to 40 N, more preferably from 16 N to 35 N, and even more preferably from 18 N to 30 N.

In particular these hardness 1 values can refer to the hardness 1 value of the fatty matrix according to the invention.

For example, for a cylinder of 20 mm diameter and a height of 20 mm, at a temperature of 4° C., an edible food product according to the invention has a hardness 2 of at least 25 N, preferably, at least 27.5 N, more preferably at least 30 N, and even more preferably at least 32.5 N.

For example, for a cylinder of 20 mm diameter and a height of 20 mm, at a temperature of 4° C., an edible food product according to the invention has a hardness 2 of at most 65 N, preferably, at most 60 N, more preferably at most 55 N, and even more preferably at most 50 N.

Hence, for example for a cylinder of 20 mm diameter and a height of 20 mm, at a temperature of 4° C., an edible food product according to the invention has a hardness 2 from 25 N to 65 N, preferably from 27.5 N to 60 N, more preferably from 30 N to 55 N, and even more preferably from 32.5 N to 50 N.

In particular these hardness 2 values can refer to the hardness 2 value of the fatty matrix according to the invention.

For example, for a cylinder of 40 mm diameter and a height of 15 mm, at a temperature of 45° C., an edible food product according to the invention has a hardness 2 of at least 8 N, preferably, at least 9 N, more preferably at least 10 N, and even more preferably at least 11 N.

For example, for a cylinder of 40 mm diameter and a height of 15 mm, at a temperature of 45° C., an edible food product according to the invention has a hardness 2 of at most 30 N, preferably, at most 27.5 N, more preferably at most 25 N, and even more preferably at most 22.5 N.

Hence, for example, for a cylinder of 40 mm diameter and a height of 15 mm, at a temperature of 45° C., an edible food product according to the invention has a hardness 2 from 8 N to 30 N, preferably from 9 N to 27.5 N, more preferably from 10 N to 25 N, and even more preferably from 11 N to 22.5 N.

In particular, these hardness 2 values can refer to the hardness 2 value of the fatty matrix according to the invention.

The cohesiveness is the resistance of the product to the second deformation compared to its resistance to the first deformation. Cohesiveness is deduced from data of both compression/release cycles applied to measure hardness 1 and 2. Hence, it is calculated as the area of work during the second compression divided by the area of work during the first compression (FIG. 2).

$$Cohesiveness = ( d + e ) / ( a + b ) .$$

For example, an edible food product according to the invention has a cohesiveness, for a cylinder of 20 mm diameter and a height of 20 mm, at a temperature of 4° C., of at most 0.080, preferably, at most 0.075, more preferably at most 0.070, and even more preferably at most 0.065.

For example, an edible food product according to the invention has a cohesiveness, for a cylinder of 20 mm diameter and a height of 20 mm, at a temperature of 4° C., of at least 0.015, preferably, at least 0.020, more preferably at least 0.025, and even more preferably at least 0.030.

Hence, for example, an edible food product according to the invention have a cohesiveness, for a cylinder of 20 mm diameter and a height of 20 mm, at a temperature of 4° C., from 0.015 to 0.080, preferably from 0.020 to 0.075, more preferably from 0.025 to 0.070, and even more preferably from 0.030 to 0.065.

In particular, these cohesiveness values can refer to the cohesiveness value of the fatty matrix according to the invention.

For example, an edible food product according to the invention has a cohesiveness, for a cylinder of 40 mm diameter and a height of 15 mm, at a temperature of 45° C., of at most 0.20, preferably, at most 0.19, more preferably at most 0.18, and even more preferably at most 0.17.

For example, an edible food product according to the invention has a cohesiveness, for a cylinder of 40 mm diameter and a height of 15 mm, at a temperature of 45° C., of at least 0.025, preferably, at least 0.05, more preferably at least 0.075, and even more preferably at least 0.1.

Hence, for example, an edible food product according to the invention has a cohesiveness, for a cylinder of 40 mm diameter and a height of 15 mm, at a temperature of 45° C., from 0.025 to 0.20, preferably from 0.05 to 0.19, more preferably from 0.075 to 0.18, and even more preferably from 0.1 to 0.17.

In particular, these cohesiveness values can refer to the cohesiveness value of the fatty matrix according to the invention.

According to a second aspect, the invention relates to a method 100 of manufacture of an edible food product comprising a fatty matrix.

The method 100 of manufacture according to the invention will preferably allow the production of an edible food product having a meat-like texture, such as the edible food product according to the invention. Preferably, a method 100 of manufacture will comprise all the steps and features making it possible to obtain a product according to the invention in its preferred or not preferred embodiments.

As illustrated in FIG. 1, the method comprising the steps of: providing plant fat and/or fermented fat 110, providing animal proteins 120 and processing 150 the said plant fat and/or fermented fat and the said animal proteins to produce a fatty matrix, in particular to produce an edible food product comprising said fatty matrix.

A food manufacturing can comprise several other steps such as: blanching, heat sterilisation, evaporation and distillation, dehydration, smoking, baking and roasting, frying, high pressure processing, Pulsed Electric Field (PEF) processing, ultrasound/cavitation/shock wave processing, pasteurisation, application of cold plasma, dielectric, ohmic and infrared processing, microwave heating/blanching/assisted extraction, food irradiation, UV microbial inactivation, pulsed light technology, supercritical extractions, extrusion, freezing, chilling, modified atmospheres, drying technologies (freeze drying, membranes), fermentation, homogenisation, mincing, grinding, chopping, salting, tumbling, curing, brine injection. In particular, the method according to the invention can also comprise several additional steps such as: adding food additives 130, homogenising 155 the fat and animal proteins; performing a heat treatment 160, combining 170 the fatty matrix with another food matrix and/or conditioning 180 the edible food product.

We have already presented in detail the general and preferred characteristics of each of the constituents of the fatty matrix and of the edible food product according to the invention. These embodiments are applicable both to the edible food product according to the invention and to the other aspects of the present invention such as the method of manufacture of said edible food product.

As shown in FIG. 1, a method 100 of manufacture of an edible food product according to the invention comprises a step of providing 110 plant fat and/or fermented fat.

This step is in particular designed to improve the textural qualities of the edible product. In particular, such treatment improves the meat-like texture of a fatty matrix. Hence, such a step contributes to the resolution of the problems solved by the invention.

As described for the edible product according to the invention, preferably the plant fat and/or fermented fat comprise triglycerides.

Hence, the plant fat and/or fermented fat can comprise at least 50% in weight of triglycerides with respect to a total weight of plant fat and/or fermented fat, preferably at least 70% in weight of triglycerides with respect to a total weight of plant fat and/or fermented fat, more preferably at least 80% in weight of triglycerides with respect to a total weight of plant fat and/or fermented fat, even more preferably at least 90% such as at least 95% in weight of fats are triglycerides with respect to a total weight plant fat and/or fermented fat.

Moreover, the plant fat and/or fermented fat triglycerides comprise more than 40% in weight of unsaturated C18 fatty acids with less than four carbon-carbon double bonds, with respect to a total weight of plant fat and/or fermented fat triglycerides. Preferably, the triglycerides of the plant fat and/or fermented fat comprise more than 45% in weight of unsaturated C18 fatty acids with less than four carbon-carbon double bonds with respect to the total weight of triglycerides in the plant fat and/or fermented fat. More preferably, the triglycerides of the plant fat and/or fermented fat comprise more than 50% in weight of unsaturated C18 fatty acids with less than four carbon-carbon double bonds with respect to the total weight of triglycerides of the plant fat and/or fermented fat. Even more preferably, the triglycerides comprise more than 55% in weight of unsaturated C18 fatty acids with less than four carbon-carbon double bonds with respect to the total weight of triglycerides in the plant fat and/or fermented fat.

Also the plant fat and/or fermented fat triglycerides comprise more than 2% in weight of polyunsaturated C18 fatty acids, with respect to a total weight of plant fat and/or fermented fat triglycerides. Preferably, the triglycerides of the plant fat and/or fermented fat comprise more than 2.5% in weight of polyunsaturated C18 fatty acids with respect to the total weight of triglycerides in the plant fat and/or fermented fat. More preferably, the triglycerides of the plant fat and/or fermented fat comprise more than 3.5% in weight of polyunsaturated C18 fatty acids with respect to the total weight of triglycerides of the plant fat and/or fermented fat. Even more preferably, the triglycerides comprise at least 7% in weight of polyunsaturated C18 fatty acids with respect to the total weight of triglycerides in the plant fat and/or fermented fat. In particular, the edible product of the invention preferably comprises a minimal concentration of linolenic acids, preferably in the form of triglycerides. Hence, in particular, as it will be shown in examples, the triglycerides of the plant fat and/or fermented fat comprise more than 0.01% in weight of linolenic acids with respect to the total weight of triglycerides in the plant fat and/or fermented fat. Preferably, the triglycerides of the plant fat and/or fermented fat comprise more than 0.10% in weight of linolenic acids with respect to the total weight of triglycerides in the plant fat and/or fermented fat. More preferably, the triglycerides of the plant fat and/or fermented fat comprise at least 1% in weight of linolenic acids with respect to the total weight of triglycerides of the plant fat and/or fermented fat. Even more preferably, the triglycerides comprise at least 2% in weight of linolenic acids with respect to the total weight of triglycerides in the plant fat and/or fermented fat.

Hence, in particular, as it will be shown in examples, the triglycerides of the plant fat and/or fermented fat comprise at least 4% in weight of stearic acid with respect to the total weight of triglycerides in the plant fat and/or fermented fat. Preferably, the triglycerides of the plant fat and/or fermented fat comprise at least 5% in weight of stearic acid with respect to the total weight of triglycerides in the plant fat and/or fermented fat. More preferably, the triglycerides of the plant fat and/or fermented fat comprise at least 10% in weight of stearic acid with respect to the total weight of triglycerides of the plant fat and/or fermented fat. Even more preferably, the triglycerides comprise at least 15% in weight of stearic acid with respect to the total weight of triglycerides in the plant fat and/or fermented fat. However, an excessive portion of stearic acid in the triglycerides of the plant fat and/or fermented fat can be detrimental to the needs solved by the invention. In preferred embodiments, the triglycerides of the plant fat and/or fermented fat comprise less than 40% in weight of stearic acid with respect to the total weight of triglycerides in the plant fat and/or fermented fat. Preferably, the triglycerides of the plant fat and/or fermented fat comprise more than 30% in weight of stearic acid with respect to the total weight of triglycerides in the plant fat and/or fermented fat. More preferably, the triglycerides of the plant fat and/or fermented fat comprise more than 20% in weight of stearic acid with respect to the total weight of triglycerides of the plant fat and/or fermented fat.

As it will be illustrated in example, an excessive amount of saturated C16-C18 fatty acid with respect to a total weight of plant and/or fermented fat triglycerides can be detrimental to the needs solved by the invention. Hence, for example, the plant fat and/or fermented fat comprises less than 60% in weight of saturated C16-C18 fatty acid with respect to a total weight of plant and/or fermented fat triglycerides; preferably than 50% in weight of saturated C16-C18 fatty acid with respect to a total weight of plant and/or fermented fat triglycerides; more preferably less than 40% in weight of saturated C16-C18 fatty acid with respect to a total weight of plant and/or fermented fat triglycerides; even more preferably less than 30% in weight of saturated C16-C18 fatty acid with respect to a total weight of plant and/or fermented fat triglycerides.

It has been discovered that an excessive portion of palmitic acid in the triglycerides of the fatty matrix can be detrimental to the needs solved by the invention. Hence, in particular, as it is shown in examples, the triglycerides of the plant fat and/or fermented fat comprise less than 59.00% in weight of palmitic acid with respect to the total weight of triglycerides in the plant fat and/or fermented fat. Preferably, the triglycerides of the plant fat and/or fermented fat comprise less than 50% in weight of palmitic acid with respect to the total weight of triglycerides in the plant fat and/or fermented fat. More preferably, the triglycerides of the plant fat and/or fermented fat comprise less than 40% in weight of palmitic acid with respect to the total weight of triglycerides in the plant fat and/or fermented fat. Even more preferably, the triglycerides of the plant fat and/or fermented fat comprise at most 35.00% in weight of palmitic acid with respect to the total weight of triglycerides in the plant fat and/or fermented fat.

On the contrary, a high portion of oleic acid in the triglycerides is found beneficial to the needs solved by the invention. Hence, in particular, as it will be shown in examples, the triglycerides of the plant fat and/or fermented fat comprise more than 33% in weight of oleic acid with respect to the total weight of triglycerides in the plant fat and/or fermented fat. Preferably, the triglycerides of the plant fat and/or fermented fat comprise more than 35% in weight of oleic acid with respect to the total weight of triglycerides in the plant fat and/or fermented fat. More preferably, the triglycerides of the plant fat and/or fermented fat comprise more than 40% in weight of oleic acid with respect to the total weight of triglycerides of the plant fat and/or fermented fat. Even more preferably, the triglycerides comprise more than 45% in weight of oleic acid with respect to the total weight of triglycerides in the plant fat and/or fermented fat.

As shown in FIG. 1, a method 100 of manufacture of an edible food product according to the invention comprises a step of providing 120 animal proteins, excluding human proteins. As mentioned, the proteins provided at this step include animal proteins (excluding human proteins) but can also comprise other proteins such as plant proteins, bacterial proteins, fungal proteins or mixture thereof.

This step is in particular designed to improve the organoleptic qualities and the textural qualities of the edible product. In particular, such treatment improves the meat-like texture of a fatty matrix. Hence, such a step contributes to the resolution of the problems solved by the invention.

As mentioned, the animal proteins, excluding human proteins, can be provided in any form compatible with the usual food processing methods. For example, the animal protein, excluding human proteins, can be provided in the form of a solution such as a protein extract obtained from cells, in the form of cells or in the form of disrupted cells. The animal proteins usable in this step can refer to all embodiments whether they are preferred or not of the edible product according to the invention.

For example, the animal proteins are preferably selected among Bovidae cells, Cervidae cells, Leporidae cells, Suidae cells, Anatidae cells, Phasianidae cells, Gadidae cells, Merlucciidae cells, Pleuronectidae cells, Salmonidae cells, Scombridae cells, Palaemonidae cells, and combination thereof. Also, preferably, the animal proteins are derived from cultivated animal cells; for example, the animal cells are selected among stem cells such as induced pluripotent stem cells, germ layers cells, fibro-adipogenic progenitors, muscle cells such as skeletal muscle cells, cardiac cells, or smooth muscle cells; hepatocytes, fibroblasts, adipocytes, chondrocytes, keratinocytes, and combination thereof.

As mentioned, the step can further include the addition of plant proteins, bacterial proteins, fungal proteins or a mixture thereof. For example, the plant proteins are preferably selected among: sunflower proteins, soybeans proteins, pea proteins, canola proteins, mung bean proteins, chickpea proteins, faba bean proteins, lentil proteins, seaweed proteins, potato proteins, quinoa proteins, nut proteins, wheat proteins, winged bean proteins, bambara bean proteins, dulse proteins, mesquite bean proteins, duckweed proteins, winged bean proteins, dry broad bean proteins, dry cow pea proteins, lupins proteins, jackfruit proteins, amaranth proteins, millet proteins, oat proteins, chia proteins, hemp seed proteins and rice proteins or a combination thereof.

A method 100 of producing an edible food product according to the invention can comprise a step of adding a food additive 130. This step is in particular designed to improve the flavour, the texture, the appearance or the shelf-life of the edible food product. The edible food product may comprise between 0.01 and 10% in weight of food additive, preferably between 0.01 and 4% in weight of food additive.

As illustrated in FIG. 1, a method according to the invention can comprise a food additive addition before 131 and/or after 132 the step of processing 150 the fat and animal proteins to produce a fatty matrix and/or after 133 the step of heat treatment 160.

The food additive can be selected from seasoning, flavouring additive, texturizer additive, food colourant, preservative additive or a combination thereof.

A seasoning can for example be selected from: salt; pepper; aromatic herbs and/or spices, including rosemary, sage, mint, oregano, parsley, thyme, bay leaf, cloves, basil, chives, marjoram, nutmeg, cardamom, chiles, cinnamon, fennel, fenugreek, ginger, saffron, vanilla and coriander; alcohol, including wine such as jurançon, sauterne or pacherenc, spirituous such as cognac or armagnac; or any combination thereof.

A flavouring additive can for example be selected from: flavour enhancer, sweetener, or any combination thereof.

A texturizer additive can for example be selected from: bulking agent or thickener, desiccant, curing agent or any combination thereof.

A preservative additive can for example be selected from: antimicrobial agent, pH modulator, or any combination thereof.

A food colourant can for example be selected from natural colourants such as carotenes, tomato, beetroot, or a mixture of thereof. The edible food product may comprise between 0.01% and 4% of food colourants.

As shown in FIG. 1, a method 100 of manufacture of an edible food product according to the invention comprises a step of processing 150 the said plant fat and/or fermented fat and the proteins including animal proteins to produce a fatty matrix.

This step is particularly designed to improve the organoleptic qualities of the edible product. In an embodiment, such processing can improve the meat-like texture of the fatty matrix and of an edible food product comprising this fatty matrix. Hence, such a step can contribute to the resolution of the problems solved by the invention.

During the processing 150 step, the fat (plant and/or fermented) can be gradually incorporated with the proteins including animal proteins or vice versa. Alternatively, the fat and the proteins can be mixed until homogeneity. Optionally, the processing 150 step can be conducted at a temperature between 30° C. and 100° C.

Preferably and as broadly described previously in connection with the preferred or non-preferred embodiments of the edible food product, the fatty matrix comprises more than 40.00% of the said plant fat and/or fermented fat in weight with respect to a total wet weight of fatty matrix, preferably the fatty matrix comprises at least 55% of the said plant fat and/or fermented fat in weight with respect to a total wet weight of fatty matrix, and more than 2.1% of the said proteins, including animal proteins, in weight with respect to the total weight of fatty matrix. Preferred embodiments of the edible food product related to the animal proteins or fat concentration are applicable to the currently described method.

The processing step can comprise a step of blending the plant fat and/or fermented fat with the said proteins, including animal proteins. Hence as shown in FIG. 1, a method 100 of manufacturing an edible food product according to the invention can comprise a homogenising 155 step. This step is in particular designed to homogenize the fatty matrix and/or to mix all the components together. Hence, the homogenising step can be a blending, emulsifying, or stirring step. During this step, an emulsion can be created, preferably a microemulsion is created. It can for example be used when the fatty matrix has been supplemented with other ingredients such as plant material or food additives or when it is combined with another food matrix.

The fatty matrix can be homogenised before and/or after the step of processing 150 the fat and animal proteins to produce a fatty matrix. The fatty matrix can be homogenised during the step of processing 150 the fat and animal proteins to produce a fatty matrix.

Preferably, the homogenising 155 step is performed with a high-speed mixer, or with a homogenizer, as a rotor-stator homogenizer, a cutter or a colloid mill.

The homogenising 155 step may be conducted during at least 30 seconds, preferably at least 1 min, more preferably at least 2 min; for example, at least 10 min. The homogenising 155 step may be conducted during at most one hour, preferably at most 45 min, more preferably at most 30 min; even more preferably at most 10 min; for example, at most 2 min. Hence, the homogenising 155 step may be conducted during 30 sec to 60 min, preferably during 1 min to 45 min, more preferably during 2 min to 30 min; for example during about 10 minutes.

The homogenising 155 step may be conducted at least at 100 rpm, preferably at least 1000 rpm, more preferably at least 2000 rpm; for example, at least 5000 rpm. The homogenising 155 step may be conducted during at most at 30 000 rpm, preferably at most 25 000 rpm, more preferably at most 20 000 rpm; for example, at most at 15 000 rpm. Hence, the homogenising 155 step may be conducted at 100 rpm to 30 000 rpm, preferably at 1000 rpm to 25 000 rpm, more preferably at 2 000 rpm to 20 000 rpm; even more preferably at 5 000 rpm to 15 000 rpm.

The homogenisation will preferably induce an emulsion, more preferably a microemulsion in the fatty matrix. Without being limited by the theory, such microemulsion improves the texture of the fatty matrix. An emulsion or microemulsion according to the present invention will generate lipidic droplets with a mean diameter of the droplet size distribution of less than 25 μm, preferably less than 20 μm, more preferably less than 15 μm and even more preferably less than 10 μm. The mean diameter of the droplet size distribution can be measured by dynamic light scattering, for example according to ISO 22412 and/or with a Mastersizer 3000 from Malvern Panalytical device.

As shown in FIG. 1, a method 100 of producing an edible food product having meat-like texture according to the invention can comprise a heat treatment 160 step. This step can in particular be designed to cook and/or precook the edible food product and develop its flavours. This step can also be designed to also sterilise the edible product.

Another advantage of this step is that it can play a major role in defining final product quality characteristics such as flavour, colour and texture.

The heat treatment 160 step can be conducted until a core temperature of at least 30° C. is reached, preferably at least 40° C. and more preferably at least 50° C. The heat treatment 160 step can be conducted during at least five minutes, preferably at least ten minutes, more preferably at least fifteen minutes.

The heat treatment 160 step can be conducted until a core temperature of at most 130° C. is reached, preferably at most 100° C., more preferably at most 80° C. and even more preferably at most 60° C. The heat treatment 160 step can be conducted during at most 120 minutes, preferably at most 60 minutes, more preferably at most 30 minutes, more preferably a most 15 minutes.

The heat treatment 160 step can be conducted until a core temperature from 30° C. to 130° C. is reached, preferably from 30° C. to 80° C., more preferably from 30° C. to 60° C. and even more preferably from 35° C. to 60° C. The heat treatment 160 step can be conducted during 5 to 60 minutes, preferably 5 to 30 minutes, more preferably 5 to 15 minutes.

Alternatively, the heat treatment step can correspond to a sterilisation or a pasteurisation.

The heat treatment step can be done using a conveyor belt and an oven, for example the oven is a tunnel oven inside which the conveyor belt runs; or using an oven; a hot liquid bath, steam projection, microwave or radiofrequency irradiation.

According to an embodiment, the method may comprise, for example after the step of heat treatment, a cooling step. Preferably, the cooling step is performed in a water bath or a cool room for example during at least one night or a cold tunnel inside which a conveyor belt runs or in a blast chiller.

As shown in FIG. 1, a method 100 of manufacturing an edible food product according to the invention can comprise a step of combining 170 the fatty matrix with another food matrix. The edible food product then comprises the fatty matrix and the other food matrix.

As described, the edible food product according to the invention will at least comprise a fatty matrix.

However, an edible food product according to the invention can comprise a mix of a fatty matrix and one or several other food matrices such as a protein matrix, a carbohydrate matrix, a plant matrix and/or a fibrous matrix. The step of combining 170 the fatty matrix with another food matrix can comprise a step of adding a transglutaminase to the fatty matrix and/or to the one or several other food matrices.

Hence, a method 100 of manufacturing an edible food product according to the invention can comprise a step of combining 170 the fatty matrix with another food matrix such as a protein matrix, a carbohydrate matrix, a plant matrix and/or a fibrous matrix.

Preferably, during the combining 170 step, the fatty matrix will have a lower viscosity than the viscosity of the other food matrix. For example, during the combining 170 step, the fatty matrix will be a fluid while the other food matrix will be a solid. There are a lot of technical means available to the person of art to combine several food matrices. For example, a suitable combining means can be selected among: 3D printing, co-extrusion, moulding, pressing, vacuuming, pressing, dosing, or a combination thereof.

As shown in FIG. 1, a method 100 of producing an edible food product according to the invention can comprise a step of conditioning 180 the edible food product.

This step is in particular designed to obtain an edible food product having meat-like properties, such as meat-like organoleptic properties in particular meat-like texture.

According to the invention, the step of conditioning 180 the edible food product can comprise steps such as steps that affect water content, shape or texture, flavour or even shelf life.

For example, according to the invention, the step of conditioning 180 the edible food product can comprise steps such as drying, desiccation, dehydration, lyophilization, filtering or a combination thereof.

For example, according to the invention, the step of conditioning 180 the edible food product can comprise steps such as sterilisation or pasteurisation.

For example, according to the invention, the step of conditioning 180 the edible food product can comprise steps such as crushing, squishing, cutting, grinding, mixing, shredding, squeezing, dosing, moulding, pressing, 3D printing, extruding or a combination thereof. It can also comprise baking or cooking steps such as smoking, roasting, frying, surface treatment, coating or a combination thereof.

Finally, according to the invention, the step of conditioning 180 the edible food product can comprise steps such as cooling, refrigeration, deep-freezing, packaging or a combination thereof.

### Examples

The invention is further described in detail by reference to the following experimental examples. These examples are provided for purposes of illustration only and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skills in the art can, using the preceding description and the following illustrative examples, make and utilise the compounds of the present invention and practise the claimed methods. The following examples, therefore, specifically point out the preferred embodiments of the present invention, and are not to be construed as limiting in any way the remainder of the disclosure.

As it has been detailed, the invention comprises an edible food product having fatty matrix with meat-like texture and preferably comprising cultivated cells or extracts thereof. These examples are in particular directed to such an aspect.

### Materials and Methods

Plant Fat and/or Fermented Fat

Plant fat and/or fermented fat can be obtained through mechanical or chemical extraction from seeds or from other parts of fruit. It can then be purified and, if required, refined or chemically altered. Many commercial references can be used such as a mix of CremoFLEX® L and CremoFLEX® E.

Alternatively, fermented fat produced by microalgae such as Bacillariophyceae, Chlorophyceae, Eustigmatophyceae, Rhodophyceae or Conjugatophyceae can be used.

The chemical analysis, in particular triglycerides or fatty acid concentrations, of the fatty substances can be carried out using the analysis and quantification methods known to those skilled in the art (e.g. using ISO 12966).

### Protein's Preparation

Duck cells were duck cells obtained from biopsies or cultivated cells. Cultivated cells can be hepatic duck progenitor cells, duck embryonic stem cells initially isolated from duck liver and adapted to grow in suspension in the serum free medium. These cells are characterised by their property to grow in suspension at a larger scale in bioreactors.

The duck cells are cultivated in a 30 L stainless steel bioreactor at 37° C., pH 7.1 regulated with CO₂ injection under constant stirring at 50 rpm. Four days post seeding, cells are collected from the bioreactor, submitted to a two-step centrifugation and the dry pellets are weighed.

The hepatocytes are then considered as duck cells suitable for use in a fatty matrix. A protein dosage can be conducted using a Bradford method.

Fresh liver from non-force-fed duck can also be used. Fresh liver is washed and weighted before being used as duck cells. A protein dosage is conducted using a Bradford method.

### Edible Food Product Preparation

The duck cells are mixed with food additives and seasonings (e.g. salt, pepper and sugar) and the plant fat is melted if necessary and then added slowly at room temperature. Then the mixture is combined using a blender.

The mix is then pre-cooked or cooked at 70° C. (water bath) for 10 min and then immediately submerged in an ice bath before storing it in the fridge.

This process can be used to produce an end-product or an intermediate product consisting in the fatty matrix.

### Texture Profile Analysis (TPA)

The texture analyses were conducted using a texture profile analysis (TPA) test. The TPA was conducted using a Lloyd Instrument LS1SH-230V texturometer paired with a compression plate probe of 80 mm diameter and Nexygen 3.0 Plus software was used.

As shown in FIG. 2, the TPA consists in applying two cycles of compression (a, d) of the sample under the probe, followed by a releasing phase (b, e), each cycle being separated by a rest phase (time between b and d), allowing the measurement of the hardness 1 and 2 (maximum of compression of each cycle) and the calculation of the cohesiveness of the sample.

The hardness is the maximum force (in Newton) applied to the edible food product sample during each compression phase of the test. It relates to the force required by the consumer, while chewing, to compress a substance between the molars, or between the tongue and the palate. In FIG. 2, hardness 1 relates to the peak of applied force (in Newton) on the sample during the first compression/release cycle and hardness 2 to the peak of applied force (in Newton) on the sample during the second compression/release cycle.
Hardness 1 (N)=F1
Hardness 2 (N)=F2

The cohesiveness is the resistance of the product to the second deformation compared to its resistance to the first deformation. It is calculated as the area of work during the second compression divided by the area of work during the first compression (FIG. 2).

$$Cohesiveness = ( d + e ) / ( a + b )$$

### Measurement of the Fat Release Properties

The quantification of the fat release phenomenon is important when evaluating the textural properties of meat products, as it can be correlated to the fat-explosion and mouthfeel that consumers experience while eating, especially while chewing.

The test to measure fat release consists in comparing the weight of samples before and after a cooking step, or before and after a cooking step followed by a compression phase under a texturometer probe.

Samples of edible food products were cut into slices 15 millimeter-high and 40 millimeter-wide, and stored at 15° C. in order to even out the core temperature of all the samples. Once it was achieved, they were weighed individually.

Two measurements were performed: (i) fat release measurements after pan-frying the samples on a surface temperature of 180° C. during 60 seconds per side; and (ii) fat release measurements of pan-fried samples of phase (i) during a subsequent compression phase after the pan-frying step in order to mimic the force applied during the first bite when fat is released from the product in the mouth. The compression plate probe of 80 mm diameter of a Lloyd Instrument LS1SH-230V texturometer was used to apply a compression force on the edible food product.

Each sample was pan-fried individually at a surface temperature of 180° C. during 60 seconds per side. Samples were weighed again after pan-frying. A first paper napkin was weighed, then used to collect and absorb the fat that leaked on the pan-frying surface. The first paper napkin full of fat was then weighed again.

Prior to starting compression, each pan-fried sample was placed on a second pre-weighed paper napkin and under the probe of the texturometer. The probe was set to drive to a limit of 0 mm at a speed of 100 mm/min for a duration of 30 seconds, in order to crush the samples once.

After compression, samples were weighed again. The second paper napkin was also weighed with the absorbed fat during compression.

Finally, the percentages of weight loss were calculated for each sample. The difference of weight of the first paper napkin before and after pan-frying equals the weight of fat released during cooking. The difference of weight of the second paper napkin before and after compression equals the weight of fat released during eating.

The capacity of samples to release fat during cooking (e.g. pan-frying) can be expressed in w/w % using the following equation:

$$( ( weight of fat absorbed by the first paper napkin after cooking ) \text{} / ( weight of sample before cooking ) ) * 100$$

The capacity of samples to release fat during compression (e.g. mimicking chewing) can be expressed in w/w % using the following equation:

$$( ( weight of fat absorbed by the second paper napkin after compression ) \text{} / ( weight of sample after cooking ) ) * 100$$

### Sensory Evaluations

Food samples were anonymized before tasting. Additionally, panellists were offered tap water for rinsing their mouth between samples and a cracker, to reset flavour receptors.

Moreover, panellists evaluated the edible food product samples after tasting the products on overall liking and meat-like flavour. For example, when foie gras substitutes were tested, panellists evaluated the edible food product samples also on foie gras flavour.

### Influence of the Composition of the Fatty Matrix

Table 1 below shows compositions which either may (invention) or may not (comp.) solve the technical problem addressed by the present invention.

In particular, different concentrations of proteins, fats and triglycerides are tested and the effect of these concentrations on the texture is evaluated in order to find the ones having the consumer's approval. Testing is conducted on cold (about 5° C.) and hot (about 40° C.) composition. The fatty matrix that is produced in these experiments needs to produce an appropriate mouthfeel in cold and hot conditions, mimicking the mouthfeel whilst eating a meat product.

The table 1 below shows the quantity used for each of the preparations.

TABLE 1

| | 1A | 1B | 1C | 1D | 1E |
|---|---|---|---|---|---|
| Ingredients (% w wet fatty matrix) | (comp.) | (comp.) | invention | invention | invention |
| Plant Fat (% w wet fatty matrix) | 40.00% | 89.20% | 50.00% | 80.20% | 62.20% |
| including triglycerides (% w plant fat) | 60.00% | 60.00% | 35.00% | 50.00% | 92.00% |
| Duck cells (% w wet fatty matrix) | 57.20% | 8.00% | 47.20% | 17.00% | 35.00% |
| including duck proteins (% w wet fatty matrix) | 7.15% | 1.00% | 6.28% | 2.13% | 4.97% |
| Salt (% w wet fatty matrix) | 1.00% | 1.00% | 1.00% | 1.00% | 1.00% |
| Sugar (% w wet fatty matrix) | 1.50% | 1.50% | 1.50% | 1.50% | 1.50% |
| White Pepper (% w wet fatty matrix) | 0.30% | 0.30% | 0.30% | 0.30% | 0.30% |
| Total (% w) | 100.00% | 100.00% | 100.00% | 100.00% | 100.00% |
| Texture | Bad - | Bad- | Good at | Good at | Good- |
| | stable | No stable | 4° C.- | 4° C. and | Stable |
| | emulsion | emulsion | Acceptable | 40° C. | emulsion, |
| | but not | | at 40° C. | Stable | low fat |
| | acceptable | | | emulsion | loss during |
| | mouthfeel | | | | cooking |

The preparation 1A & 1B are comparative (comp.) examples. They are not related to the invention. The product that can be generated from these two compositions does not have a texture expected for a meat substitute. For example, the product that is obtained with preparation 1A may exhibit mouthfeel problems while the other (2A) do not form a stable emulsion.

Conversely, the compositions 1C, 1D, & 1E make it possible to obtain a product having a texture expected for a meat substitute. In particular, the composition 1D may have a better texture at 40° C. compared to the composition 1C. Moreover, the composition 1E may show a lower release of fat during cooking compared to the composition 1D. Without being limited by theory it could be linked to a higher concentration of triglycerides and/or proteins.

### Influence of the Fatty Acid Composition of the Plant or Fermented Fat

The fatty acid composition of the fat used in the fatty matrix of the edible food product of the invention is of great importance for the stability of the emulsion and the texture obtained.

Table 2 below shows compositions which either may (invention) or may not (comp.) solve the technical problem addressed by the present invention. Different concentrations of fatty acids are proposed and the effect of these concentrations on the texture is evaluated. As previously, several compositions are tested on a fatty matrix comprising duck cells in order to find the ones having the consumer's approval. Testing is conducted on cold (about 5° C.) and hot (about 40° C.) composition. The fatty matrix that is produced in these experiments needs to display an appropriate mouthfeel in cold and hot conditions, mimicking the mouthfeel whilst eating a meat product.

TABLE 2

| | 2A | 2B | 2C | 2D | 2E | 2F |
|---|---|---|---|---|---|---|
| Ingredients | (comp.) | (comp.) | invention | invention | invention | invention |
| Plant Fat | 65.00% | 65.00% | 65.00% | 65.00% | 65.00% | 65.00% |
| (% w wet fatty matrix) | | | | | | |
| Including Triglycerides | 92.00% | 92.00% | 92.00% | 92.00% | 92.00% | 92.00% |
| (% w plant fat) | | | | | | |
| Palmitic acid | 59.00% | 28.00% | 31.00% | 35.00% | 31.00% | 20.00% |
| (% w plant fat) | | | | | | |
| Stearic acid | 0.00% | 15.00% | 4.00% | 0.00% | 4.00% | 15.00% |
| (% w plant fat) | | | | | | |
| Oleic acid | 33.00% | 52.00% | 58.00% | 55.00% | 55.00% | 55.00% |
| (% w plant fat) | | | | | | |
| Linoleic acid | 5.00% | 1.50% | 2.00% | 5.00% | 5.00% | 5.00% |
| (% w plant fat) | | | | | | |
| Linolenic acid | 0.00% | 0.00% | 1.50% | 2.00% | 2.00% | 2.00% |
| (% w plant fat) | | | | | | |
| Saturated C16-C18 | 59.00% | 43.00% | 35.00% | 35.00% | 35.00% | 35.00% |
| fatty acids | | | | | | |
| (% w plant fat) | | | | | | |
| Monounsaturated C18 | 33.00% | 52.00% | 58.00% | 55.00% | 55.00% | 55.00% |
| fatty acids | | | | | | |
| (% w plant fat) | | | | | | |
| Polyunsaturated C18 | 5.00% | 1.50% | 3.50% | 7.00% | 7.00% | 7.00% |
| fatty acids | | | | | | |
| (% w plant fat) | | | | | | |
| Duck cells | 32.00% | 32.00% | 32.00% | 32.00% | 32.00% | 32.00% |
| (% w wet fatty matrix) | | | | | | |
| Armagnac | 0.50% | 0.50% | 0.50% | 0.50% | 0.50% | 0.50% |
| (% w wet fatty matrix) | | | | | | |
| Sauterne | 0.20% | 0.20% | 0.20% | 0.20% | 0.20% | 0.20% |
| (% w wet fatty matrix) | | | | | | |
| Salt(% w wet fatty | 1.00% | 1.00% | 1.00% | 1.00% | 1.00% | 1.00% |
| matrix) | | | | | | |
| Sugar | 1.00% | 1.00% | 1.00% | 1.00% | 1.00% | 1.00% |
| (% w wet fatty matrix) | | | | | | |
| White Pepper (% w wet | 0.30% | 0.30% | 0.30% | 0.30% | 0.30% | 0.30% |
| fatty matrix) | | | | | | |
| Total (% w wet fatty | 100% | 100% | 100% | 100% | 100% | 100% |
| matrix) | | | | | | |
| Texture | Bad | Bad | Good at | Good at | Good | Good |
| | - | - | 4° C. and | - | - | - |
| | No stable | No stable | 40° C. | 4° C. | Stable | Stable |
| | emulsion | emulsion | | Acceptable | emulsion, | emulsion, |
| | | | | at 40° C. | low fat | low fat |
| | | | | | loss | loss |
| | | | | | during | during |
| | | | | | cooking | cooking |

The tests carried out from variable concentrations of fats and triglycerides make it possible to assess the importance of the composition on the organoleptic satisfaction brought to the consumer. The composition 2A & 2B are comparative (comp.) examples. They are not related to the invention as they have low concentrations of unsaturated C18 fatty acids and in particular low concentrations of polyunsaturated C18 fatty acids.

The preparations 2E and 2F give the best results with good results for preparation 2C. For the preparation 2D, the texture is good at low temperature but just acceptable at high temperature.

### Composite Edible Food Product Preparation

As it has been mentioned, the invention relates also to an edible food product comprising a combination of matrices, including a fatty matrix according to the invention. Hence, it can be used to produce, for example, a marbled beef substitute, dried duck breast substitute comprising cultivated duck cells and plant material.

A composite edible food product can be produced with an extrusion device using a first blend of a protein matrix and a second blend of the fatty matrix according to the invention for the marbled beef. For the dried duck breast substitute, it can be produced with a 3D printing device using a first blend of a plant matrix and a second blend of the fatty matrix according to the invention.

The table 3 below illustrates an example of fatty matrix and protein matrix that can be used to produce a composite edible food product such as marbled beef substitute.

TABLE 3

| | | Marbled beef |
|---|---|---|
| Ingredients | | substitute |
| Fatty matrix 10% in | Plant Fat (% w wet fatty matrix) | 79.20% |
| weight in respect to | including triglycerides (% w plant fat) | 80.00% |
| total wet weight of | Beef cells extracts (% w wet fatty matrix) | 14.3% |
| composite edible | including beef proteins (% w wet fatty matrix) | 1.30% |
| product | Plant proteins (% w wet fatty matrix) | 3.7% |
| | Salt (% w wet fatty matrix) | 1.00% |
| | Sugar (% w wet fatty matrix) | 1.50% |
| | White Pepper (% w wet fatty matrix) | 0.30% |
| | Total (% w wet fatty matrix) | 100.00% |
| Protein Matrix 90% in | Plant Fat (% w wet protein matrix) | 10.00% |
| weight in respect to | including triglycerides (% w plant fat) | 80.00% |
| total wet weight of | Beef cells (% w wet protein matrix) | 87.20% |
| composite edible food | including beef proteins (% w wet protein matrix) | 10.90% |
| product | Salt (% w wet protein matrix) | 1.00% |
| | Flavouring agent (% w wet protein matrix) | 1.50% |
| | Sweet potato pigment (% w wet protein matrix) | 0.30% |
| | Total (% w) | 100.00% |

The table 4 below illustrates an example of fatty matrix and plant matrix that can be used to produce a composite edible food product such as a dried duck breast substitute.

TABLE 4

| | | Dried duck breast |
|---|---|---|
| Ingredients | | substitute |
| Fatty matrix 15% in | Plant Fat (% w wet fatty matrix) | 84.5% |
| weight in respect to | including triglycerides (% w plant fat) | 80.00% |
| total wet weight of | Duck cells extracts (% w wet fatty matrix) | 10.00% |
| composite edible food | including Duck proteins (% w wet fatty matrix) | 1.00% |
| product | Soy protein isolate (% w wet fatty matrix) | 2.90% |
| | Salt (% w wet fatty matrix) | 1.50% |
| | Sugar (% w wet fatty matrix) | 1.00% |
| | White Pepper (% w wet fatty matrix) | 0.10% |
| | Total (% w) | 100.00% |
| Plant Matrix 85% in | Plant material (% w wet plant matrix) | 87.20% |
| weight in respect to | including plant proteins (% w wet plant matrix) | 30.00% |
| total wet weight of | Duck cells extracts (% w wet plant matrix) | 6.00% |
| composite edible food | including Duck proteins (% w wet plant matrix) | 1.15% |
| product | Flavouring agent (% w wet plant matrix) | 2.00% |
| | Gluten powder (% w wet plant matrix) | 2.00% |
| | Salt (% w wet plant matrix) | 1.00% |
| | Sugar (% w wet plant matrix) | 1.50% |
| | Sweet potato pigment (% w wet plant matrix) | 0.30% |
| | Total (% w) | 100.00% |

As illustrated, the fatty matrix according to the invention, comprising cultivated animal cells, such as beef or duck cells extracts, and plant fat can be combined with a plant matrix comprising mainly plant material (such as plant protein extract) combined with animal cells extracts to produce through an extrusion process a substitute to duck breast or further meat substitutes whose drying can be finalised during a dedicated process. In order to facilitate the cohesion between the heterogeneous matrices, a transglutaminase can be used for example at 0.1 IU/g.

### Texture of an Edible Food Product According to the Invention

Texture is among the main parameters for consumer acceptance of food products. However, the reproduction of a meat texture, in particular from cultured cells, is complex.

Hence, the texture profile analysis has been conducted to compare the texture of an edible meat substitute comprising the fatty matrix according to the invention to the texture of two commercial food products: a conventional foie gras and a plant-based foie gras substitute.

Table 5 below shows the TPA characteristics of a composition according to the invention (Sample 3C), of a conventional foie gras (Sample 3A) and of a plant-based foie gras substitute (Sample 3B). The TPA were performed at a temperature of 4° C. on a cylinder of 20 mm diameter and 20 mm high.

TABLE 5

| | | Hardness1 | Hardness 2 | Cohesiveness |
|---|---|---|---|---|
| Samples | | (N) | (N) | [TPA] |
| Sample 3A | Mean | 72.53 | 37.01 | 0.03 |
| (Comp.) | Standard | 6.85 | 2.59 | 0.01 |
| | deviation | | | |
| Sample 3B | Mean | 31.56 | 19.97 | 0.09 |
| (Comp.) | Standard | 3.69 | 1.57 | 0.01 |
| | deviation | | | |
| Sample 3C | Mean | 63.29 | 43.58 | 0.06 |
| (Invention) | Standard | 2.80 | 1.84 | 0.01 |
| | deviation | | | |

As illustrated in this table 5, the food product according to the present invention (Sample 3C) shows similar texture properties compared to the conventional food product (Sample 3A). Additionally, the invention shows better performance than the sample 3B, which is a plant-based foie gras substitute.

In particular, an edible food product according to the invention has a hardness similar or identical to that of a conventional foie gras. Indeed, whereas a plant-based substitute has a hardness 1 below 40 N, the product comprising a fatty matrix according to the invention has a hardness 1 higher than 50 N as the conventional food product.

Also, the cohesiveness is significantly improved with an edible food product according to the invention compared to the cohesiveness of a plant-based foie gras substitute.

Hence, this TPA shows that an edible food product comprising a fatty matrix according to the invention can have a texture similar to conventional meat.

### Fat Release Properties of an Edible Food Product According to the Invention

As it has been mentioned, the fat release phenomenon during cooking and chewing is important when evaluating the textural properties of meat products, especially high fat content meat products such as marbled beef or foie gras. Also, the fat release phenomenon can be correlated to the fat-explosion and mouthfeel that consumers experience while chewing.

As an edible food product according to the invention comprises a fatty matrix, a way of evaluating its ability to mimic the behaviour of a conventional food product has been to evaluate the quantity of leaked fat during a pan-fried style cooking.

Fat release measurements have been conducted to compare the leaked fat of an edible meat substitute comprising the fatty matrix according to the invention to the leaked fat of two commercial food products: vacuum-packed conventional foie gras and a frozen conventional foie gras.

Table 6 below shows the results of fat release measurements of a composition according to the invention (Sample 4C), a vacuum-packed conventional foie gras (Sample 4A) and a frozen conventional foie gras defrosted at ambient temperature (Sample 4B).

TABLE 6

| | | Fat released | Fat released |
|---|---|---|---|
| | | during cooking | during com- |
| Samples | | (w/w %) | pression (w/w %) |
| Sample 4A | Mean | 13.57 | 29.01 |
| (Comp.) | Standard deviation | 0.65 | 2.61 |
| Sample 4B | Mean | 32.97 | 43.97 |
| (Comp.) | Standard deviation | 2.84 | 4.17 |
| Sample 4C | Mean | 12.54 | 27.10 |
| (Invention) | Standard deviation | 1.01 | 2.08 |

As illustrated in this table 6, the food product according to the present invention (Sample 4C) shows similar fat release properties compared to the conventional vacuum-packed food product (Sample 4A). Indeed, whereas a frozen food product (Sample 4B) will leak more than 30% of its initial weight in fat, a product comprising a fatty matrix according to the invention will leak less than 15% of fat during cooking.

Moreover, the results of the fat released during compression show that even under conditions of mechanical stress, such as those that may occur when cooking, a product comprising a fatty matrix according to the invention will behave as a conventional food product.

Also, such behaviour can be correlated to the fat-explosion that the consumer experiences in the mouth while chewing it.

The results also show that the product according to the invention has a behaviour similar to conventional meat even during cooking. Moreover, an edible food product comprising a fatty matrix according to the invention has a cooking behaviour similar to the cooking behaviour of a conventional product and thus reproduces for the consumer the experience of cooking conventional food products.

Hence, this fat release experience shows that an edible food product comprising a fatty matrix according to the invention has a texture similar to meat, even when cooked at high temperature.

Thus, in general, the results showed that a product including the fatty matrix according to the invention has a texture before cooking, while cooking, after cooking and while chewing, similar to a conventional meat. The food product according to the present invention exhibits overall qualities close to those of meat and matching the consumer experience when cooking and eating meat.

### Sensory Evaluations of Edible Food Products

The products according to the invention showed textural properties similar to those of conventional products. To further evaluate organoleptic properties of food products according to the invention, sensory evaluations were conducted for an edible food product preparation according to the invention (Sample 3C) in comparison to a conventional foie gras (Sample 3A) and a plant-based foie gras substitute (Sample 3B). The sensory evaluations included 16 panellists.

Out of the 16 panellists, all of them were able to identify the plant-based substitute (Sample 3B). Only 1 panelist was able to guess which was the edible food product preparation according to the invention (Sample 3C), meaning that more than 93% confused the edible food product according to the invention with conventional foie gras.

Hence, an edible food product comprising the fatty matrix according to the present invention induces the generation of a meat-like texture within a food product. Panellists could not distinguish the substitute edible food product according to the invention from conventional high-end meat, further proving that such an edible food product has similar organoleptic properties to meat.

The invention can be the subject of numerous variants and applications other than those described above. In particular, unless otherwise indicated, the different structural and functional characteristics of each of the implementations described above should not be considered as combined and/or closely and/or inextricably linked to each other, but on the contrary as simple juxtapositions. In addition, the structural and/or functional characteristics of the various embodiments described above may be the subject in whole or in part of any different juxtaposition or any different combination.

1. Edible food product, comprising a fatty matrix, said fatty matrix comprising more than 40.00% of plant fat and/or fermented fat by weight with respect to a total weight of fatty matrix, wherein triglycerides in said fatty matrix comprise:
more than 40% by weight of unsaturated C18 fatty acids with less than four carbon-carbon double bonds, with respect to a total weight of said triglycerides,
more than 2% by weight of polyunsaturated C18 fatty acids, with respect to a total weight of said triglycerides,
said fatty matrix further comprising more than 2.10% of proteins by weight with respect to the total weight of the fatty matrix, said proteins including non-human animal proteins.

2. The edible food product according to claim 1, said fatty matrix comprising at least 1% by weight of said non-human animal proteins with respect to the total weight of the fatty matrix, and said non-human animal proteins are selected among Mammalia proteins, Aves proteins, Actinopterygii proteins, Malacostraca proteins, and combination thereof.

3. The edible food product according to claim 1, wherein the non-human animal proteins are derived from cultivated animal cells.

4. The edible food product according to claim 1, wherein the plant fat and/or fermented fat comprises at least 50% by weight of triglycerides with respect to a total weight of the plant fat and/or fermented fat.

5. The edible food product according to claim 1, wherein the fatty matrix comprises less than 60% by weight of saturated C16-C18 fatty acid with respect to the total weight of said triglycerides.

6. The edible food product according to claim 1, wherein the fatty matrix comprises at most 35.00% by weight of palmitic acids with respect to the total weight of said triglycerides.

7. The edible food product according to claim 1, wherein the fatty matrix comprises at least 4.00% by weight of stearic acid with respect to the total weight of said triglycerides.

8. The edible food product according to claim 1, wherein the fatty matrix comprises at least 0.01% by weight of linolenic acid with respect to the total weight of said triglycerides.

9. The edible food product according to claim 1, wherein the fatty matrix comprises more than 40.00% by weight of oleic acid with respect to the total weight of said triglycerides.

10. The edible food product according to claim 1, further comprising a protein matrix, a carbohydrate matrix, a plant matrix and/or a fibrous matrix in contact with the fatty matrix.

11. The edible food product according to claim 1, comprising at least 10% by weight of the fatty matrix with respect to a total weight of the edible food product.

12. The edible food product according to claim 1, comprising a foie gras substitute, a marbled-meat substitute, or a fish flesh substitute.

13. The edible food product according to claim 1, having fat release properties such that, during pan frying at a surface temperature of 180° C. for 60 seconds per side, the edible food product releases at most 30% by weight of fat with respect to a total weight of the edible food product.

14. The edible food product according to claim 1, having fat release properties such that, during a compression test, the edible food product releases at most 42% by weight of fat with respect to a total weight of the edible food product.

15. The edible food product according to claim 1, having a hardness 1, at a temperature of 4° C., of at least 40 N.

16. The edible food product according to claim 15, having a hardness 2, at a temperature of 4° C., of at least 25 N.

17. The edible food product according to claim 16, having cohesiveness, at a temperature of 4° C., of at most 0.080.

18. A method of manufacture of an edible food product comprising a fatty matrix, the method comprising the steps of:
Providing plant fat and/or fermented fat, said plant fat and/or fermented fat comprising triglycerides, said triglycerides comprising:
more than 40% by weight of unsaturated C18 fatty acids with less than four carbon-carbon double bonds, with respect to a total weight of said triglycerides,
more than 2% by weight of polyunsaturated C18 fatty acids, with respect to the total weight of said triglycerides,
Providing proteins, including non-human animal proteins; and
Processing the said plant fat and/or fermented fat and the said proteins to produce an edible food product comprising a fatty matrix, said fatty matrix comprising:
more than 40.00% of the said plant fat and/or fermented fat by weight with respect to a total weight of fatty matrix, and
more than 2.10% of the said proteins by weight with respect to the total weight of the fatty matrix, said proteins including non-human animal proteins.

19. The method of manufacture according to claim 18, further comprising a step of combining the fatty matrix with another food matrix, said other food matrix being selected from a protein matrix, a carbohydrate matrix, a plant matrix and/or a fibrous matrix.

20. The method of manufacture according to claim 18, further comprising a step of homogenising the plant fat and/or fermented fat with the said proteins including non-human animal proteins.
